(19) United States
(12) Patent Application Publication
(10) Pub. No.: US 2025/0328775 A1
(43) Pub. Date: Oct. 23, 2025

(54) METHODS AND APPARATUS FOR QUALITY-OF-SERVICE AWARE LOAD BALANCING IN WIRELESS NETWORKS

(71) Applicant: Intel Corporation, Santa Clara, CA (US)

(72) Inventors: Omid Semiari, Santa Clara, CA (US); Hosein Nikopour, San Jose, CA (US)

(73) Assignee: Intel Corporation, Santa Clara, CA (US)

(21) Appl. No.: 19/253,218

(22) Filed: Jun. 27, 2025

Related U.S. Application Data
(60) Provisional application No. 63/786,753, filed on Apr. 10, 2025.

(51) Int. Cl. G06N 3/092; G06N 3/042

(52) U.S. Cl. CPC G06N 3/092; G06N 3/042

(57) ABSTRACT

Systems, apparatus, articles of manufacture, and methods are disclosed. An example apparatus includes interface circuitry, machine-readable instructions, and programmable circuitry to at least one of instantiate or execute the machine-readable instructions to generate potential actions to, if implemented, re-assign a client device in the wireless network from a first base station device in the wireless network to another base station device in the wireless network, wherein the re-assignment is to cause the first base station device to stop communications with the client device and is to cause the another base station device to begin communications with the client device; execute a first machine learning model to predict which of the potential actions would satisfy a quality of service (QoS) threshold; execute a second machine learning model to select one of the potential actions predicted to satisfy the QoS threshold; and implement the selected action within the wireless network.

### RELATED APPLICATION

This patent claims the benefit of U.S. Provisional Patent Application No. 63/786,753, which was filed on Apr. 10, 2025. U.S. Provisional Patent Application No. 63/786,753 is hereby incorporated herein by reference in its entirety. Priority to U.S. Provisional Patent Application No. 63/786,753 is hereby claimed.

### FIELD OF THE DISCLOSURE

This disclosure relates generally to wireless networking and, more particularly, to methods and apparatus for Quality-of-Service (QOS) aware load balancing in wireless networks.

### BACKGROUND

Cell towers are nodes within a Radio Access Network (RAN) that connect user equipment (UE) devices to a core network such as the Internet. In recent years, the number of UE devices within a given RAN have increased. UE devices include but are not limited to cell phones, tablets, laptops, smart watches, security cameras, etc.

### BRIEF DESCRIPTION OF THE DRAWINGS

FIG. 1 is a block diagram of an example environment in which Near Real Time Radio Access Network Intelligent Controller (Near-RT RIC) circuitry operates to perform Quality of Service (QOS) aware load balancing in wireless networks.

FIG. 2 is a block diagram of an example implementation of the Near-RT RIC circuitry of FIG. 1.

FIG. 3 is a block diagram of an example implementation of the Action Masking (AM) agent circuitry of FIG. 2.

FIG. 4 is a block diagram of an example implementation of the Graph Reinforcement Learning Load Balancing (GRL LB) agent circuitry of FIG. 2.

FIG. 5 is a flowchart representative of example machine-readable instructions and/or example operations that may be executed, instantiated, and/or performed by example programmable circuitry to implement the manager circuitry of FIG. 2.

FIG. 6 is a flowchart representative of example machine-readable instructions and/or example operations that may be executed, instantiated, and/or performed by example programmable circuitry to implement the AM agent circuitry of FIG. 2.

FIG. 7 is a flowchart representative of example machine-readable instructions and/or example operations that may be executed, instantiated, and/or performed by example AM agent circuitry of FIG. 2 to generate a mask based on context information.

FIG. 8 is a flowchart representative of example machine-readable instructions and/or example operations that may be executed, instantiated, and/or performed by example programmable circuitry to implement the GRL LB agent circuitry of FIG. 2.

FIG. 9 is a first graph describing an example performance of the Near-RT RIC circuitry of FIG. 1.

FIG. 10 is a second graph describing an example performance of the Near-RT RIC circuitry of FIG. 1.

FIG. 11 is a third graph describing an example performance of the Near-RT RIC circuitry of FIG. 1.

FIG. 12 is a fourth graph describing an example performance of the Near-RT RIC circuitry of FIG. 1.

FIG. 13 is a block diagram of an example processing platform including programmable circuitry structured to execute, instantiate, and/or perform the example machine-readable instructions and/or perform the example operations of FIGS. 5-8 to implement the Near-RT RIC circuitry 108 of FIG. 2.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

As cellular technology evolves, industry members have increased their UE-level Quality of Service (QOS) requirements to support emerging wireless applications (e.g., including but not limited to autonomous vehicles, Internet of Things (IoT) applications, etc.). These heightened QoS requirements force Radio Access Networks (RANs) to, among other things, support strict performance guarantees related to link-level data rates.

A primary challenge in meeting QoS requirements is the prevention of cell congestion, which involves balancing the load to ensure sufficient radio resources are available for each cell tower to serve its designated UE devices. In overloaded networks, a RAN can utilize load balancing (LB) to offload UE devices from congested cells to nearby underloaded cells. By carefully designing LB constraints, such forced handovers can free up resources to alleviate cell congestion without compromising the performance of the offloaded UE devices. However, performing load balancing while meeting QoS requirements is difficult in real-world scenarios due to the mixed QoS requirements from different UEs device, and due to non-deterministic factors such as fading channel, interference, UE device mobility, and traffic variations. As used above and herein, a cell tower may be referred to as a cell or as a base station device.

Known techniques to perform load balancing in a RAN do so using different approaches. Some known techniques perform cell range expansion by adjusting handover parameters such as Cell Individual Offset (CIO) values, cell breathing techniques, and threshold-based traffic steering. However, such techniques are designed based on long-term traffic patterns and are too simple to deal with the UE-level QoS requirements in real-world networks. Other known techniques perform load balancing using linear programming, but such techniques are limited to intra-site LB and are non-deterministic. Thus, such techniques cannot provide data rate guarantees (which are included in many modern QoS requirements) due to the probabilistic nature of such guarantees.

Still other known techniques use machine learning to perform LB with a RAN based on mobility predictions of UE devices, historic data that drives cell clustering, or CIO optimization. These techniques focus on cell-level information and do not consider UE-level QoS requirements in their design. Moreover, the known ML techniques face scalability issues as they take fixed-sized inputs and therefore do not generalize to RAN environments with different topologies.

Example methods, apparatus, and systems introduces a novel hierarchical learning (HL) solution to optimize the performance of Guaranteed Bit Rate (GBR) and Best-effort (BE) traffic in a multi-band Open Radio Access Network (O-RAN) under QoS and resource constraints. Example Near Real Time Radia Access Network Intelligent Controller (Near-RT RIC) circuitry described herein include two machine learning models: Action Masking (AM) agent circuitry and Graph Reinforcement Learning Load Balancing (GRL LB) agent circuitry. The example AM agent circuitry is trained with deep learning as a contextual multi-armed bandit agent that excludes certain assignments of UE devices to cells for having low predicted QoS scores. The example GRL LB agent circuitry is trained using deep GRL that performs load balancing with only the assignment options deemed permissible by the AM agent circuitry. To do so, the GRL LB agent circuitry leverages a graph neural network (GNN) to extract useful RAN information (e.g., graph embeddings) cognizant of the network topology, UE/cell features, and QoS requirements. The example Near-RT RIC circuitry trains the two machine learning models together in a feedback loop. As a result, the examples described herein performs RAN load balancing in a manner that is more scalable and supports a greater variety of RAN topologies and QoS requirements, than known techniques.

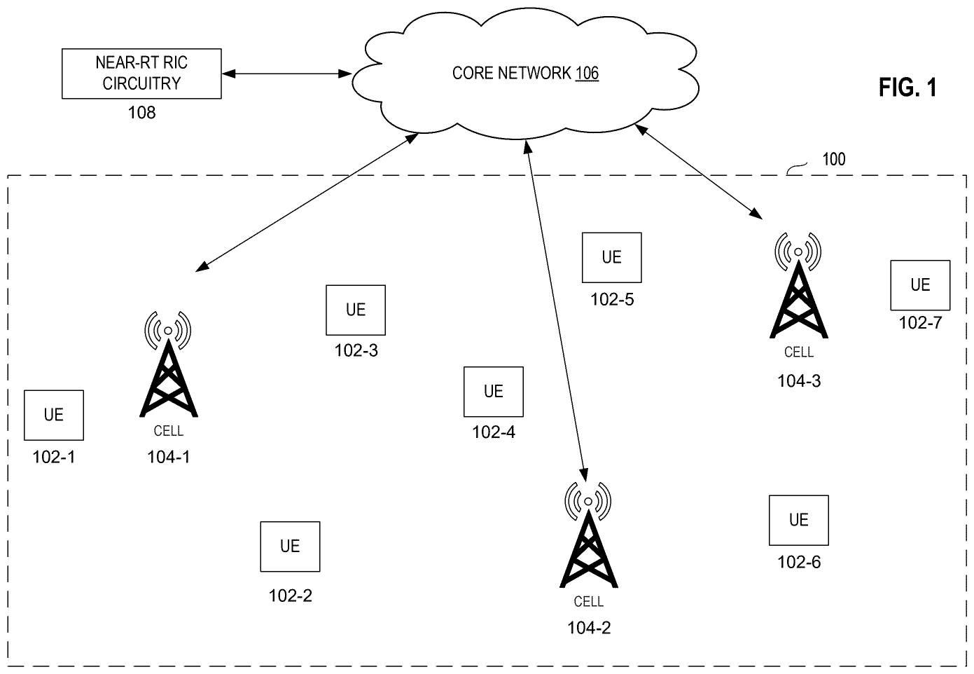

FIG. 1 is a block diagram of an example Radio Access Network (RAN). FIG. 1 has an example geographic region 100 that includes example User Equipment (UE) devices 102-1, 102-2, . . . , 102-7 (collectively referred to as UE devices 102) and example cells 104-1, 104-2, and 104-3 (collectively referred to as cells 104). In some examples, the geographic region 100 is referred to as a RAN environment. FIG. 1 also includes an example core network 106 and example Near-RT RIC circuitry 108.

The UE devices 102 refer to any devices that rely on the cells 104 to connect to the core network 106. Once connected, a given UE device 102-1 may perform any type of data communication with the core network 106. Examples of such communication include but is not limited to fourth generation (4G) or fifth generation (5G) Internet browsing, Short Message Service (SMS) or Multimedia Messaging Service (MMS) texting, second generation (2G) or third generation (3G) phone calls, etc. In some examples, a UE device 102-1 is referred to as a client device.

UE devices include but are not limited to cell phones, tablets, laptops, smart watches, security cameras, Virtual Reality (VR)/Augmented Reality (AR) headsets, etc. More generally, UE devices may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

Many UE devices are mobile devices. Accordingly, at any given time, any number of UE devices may move enter the geographic region 100, exit the geographic region 100, and/or move throughout the geographic region 100. Furthermore, because UE devices are owned and operated by users, their movement is non-deterministic and not controllable by the Near-RT RIC circuitry 108. In the example of FIG. 1, there are seven UE devices 102 within the geographic region 100. In other examples, there are a different number of UE devices 102 within the geographic region 100 due to UE device movement. Similarly, in some examples, the UE devices 102 are located at different positions within the geographic region 100 due to UE device movement.

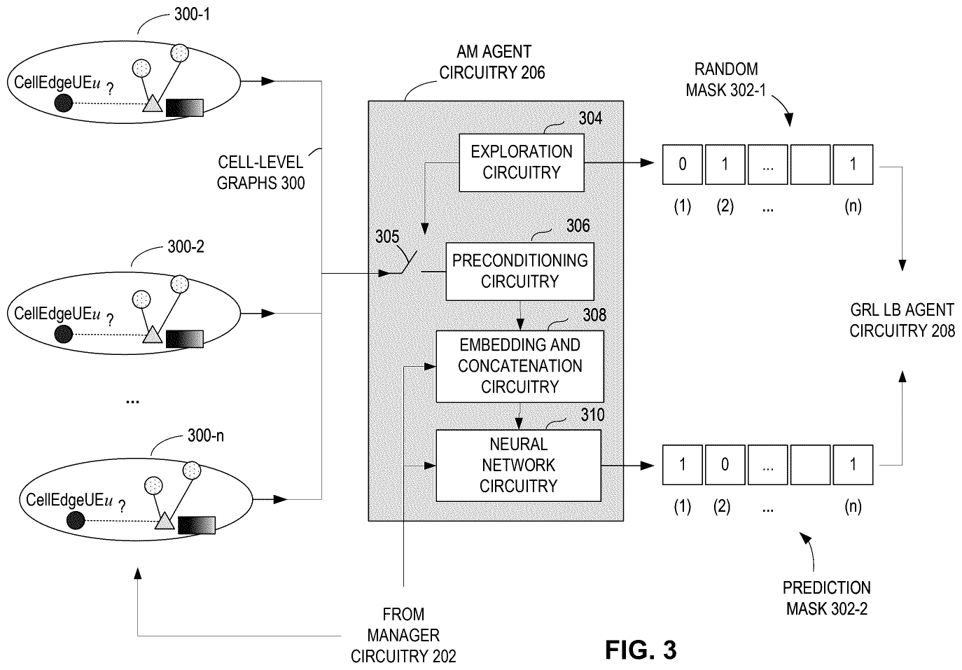

The cells 104 are intermediary devices that connect the UE devices 102 to the core network 106. A given cell 104-1 does so by a) receiving data from its assigned UE devices and forwarding said data to the core network 106 and b) receiving data from the core network 106 and forwarding said data to one of its assigned UE devices. The cells 104 may include any hardware components to support such operations, including but not limited to any form of programmable circuitry and one or more antennas. In this example, there are three cells 104 in the geographic region 100. In other examples, there are a different number of cells 104 in the geographic region 100. In the example of FIG. 3, there are three cells 104-1, 104-2, and 104-3 at three different sites within the geographic region 100. In other examples, multiple cells 104 are implemented at the same sites (e.g., multiple base station devices are implemented on the same tower). In such examples, cells that are implemented at the same location operate at different frequencies to provide both coverage and capacity to meet the traffic demand. In some examples, a given cell 104-1 is implemented by a combination of Distributed Unit (DU) circuitry and Radio Unit (RU) circuitry as defined by the O-RAN Alliance standards.

As used above and herein, a UE device 102-1 is assigned to a cell 104-1 if the cell 104-1 is responsible for connecting the cell 104-1 to the core network 106. A given UE device 102-1 is assigned to only one cell at a time, a given cell 104-1 may be assigned to multiple UE devices 102 simultaneously. Assignments between the UE devices 102 and the cells 104 may continually change at any time and for any reason. Such reasons include but are not limited to the number of UE devices 102 within the geographic region, the location of the UE devices 102 relative to the cells 104, the amount and type of data requested by the UE devices 102, etc. In some examples, the terms “assignment” and “access link” may be used interchangeably.

The core network 106 connects the UE devices 102 to other devices on a global scale in a manner that supports Internet access, text messaging, voice calls, etc. In this example, the core network 106 is the Internet. However, the example core network 106 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The Near-RT RIC circuitry 108 determines and adjusts assignments between the UE devices 102 and the cells 104 in near real-time based on the teachings described herein. As used above and herein, “near real-time”refers to occurrence in a near instantaneous manner recognizing there may be real world delays for computing time, transmission, etc. Thus, unless otherwise specified, “near real-time” refers to real time+an amount of time between 10 milliseconds (ms) and 1 second.

The Near-RT RIC circuitry 108 determines and adjusts assignments based on multiple factors. For example, the various UE devices 102 have different QoS requirements that may include but are not limited to guaranteed data rates. At the same time, the hardware components and computational resources within the cells 104 place geographical limits on the devices such that a given cell 104-1 can generally support a UE device assignment in a manner that meets its QoS requirements only if the UE device is located within a certain radius from the cell 104-1. Furthermore, the number of UE devices 102, relative locations of the UE devices 102, and amount of data requested from a given UE device may change at any time in a nondeterministic manner. To balance the foregoing restraints, the Near-RT RIC circuitry 108 performs load balancing by adjusting UE device/cell assignments in a scalable and efficient manner as described further below. 9

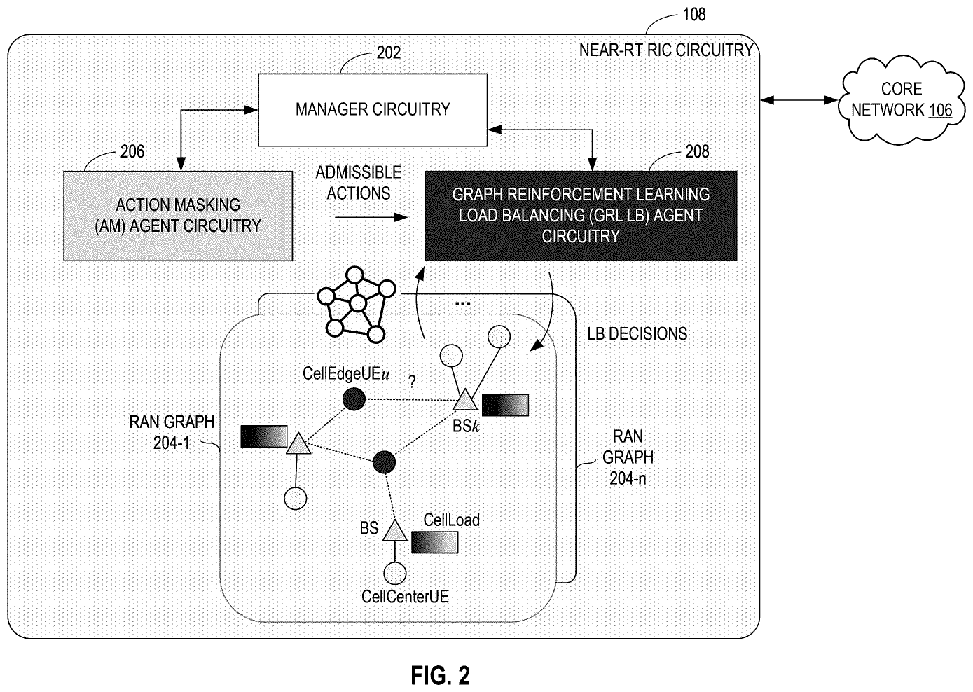

FIG. 2 is a block diagram of an example implementation of the Near-RT RIC circuitry 108 of FIG. 1 to perform load balancing. The Near-RT RIC circuitry 108 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the Near-RT RIC circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. FIG. 2 shows the Near-RT RIC circuitry 108 includes example manager circuitry 202, example RAN graphs 204-1, . . . 204-n (collectively referred to as RAN graphs 204), example Action Masking (AM) agent circuitry 206, and example Graph Reinforcement Learning Load Balancing (GRL LB) agent circuitry 208.

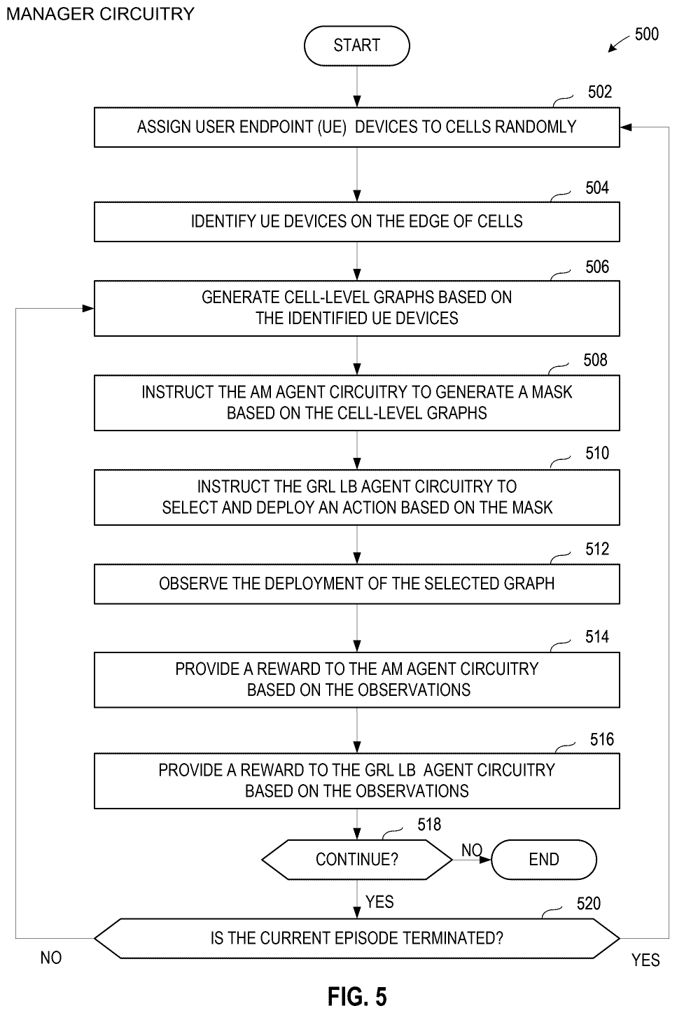

The manager circuitry 202 controls the operations of the other components within the Near-RT RIC circuitry 108. For example, the manager circuitry 202 generates potential UE-cell access links and provides them to the AM agent circuitry 206 as inputs. The manager circuitry 202 also generates the RAN graphs 204 and provides them to the GRL LB agent circuitry as inputs. The manager circuitry 202 also controls the training of the AM agent circuitry 206 and GRL LB agent circuitry 208 by observing the RAN of FIG. 1 after a particular RAN graph 204 has been deployed, generating feedback based on radio access network observations, and providing the feedback to the machine learning models. In some examples, the manager circuitry 202 is instantiated by programmable circuitry executing manager instructions and/or configured to perform operations such as those represented by the flowchart(s) of FIGS. 5-8.

The RAN graphs 204 represent potential configurations of the RAN environment of FIG. 1. For example, a given RAN graph 204-1 represents both the UE devices 102 and the cells 104 as heterogeneous nodes (e.g., vertices). In the example of FIG. 2, the nodes that represent UE devices 102 are shaped as circles and nodes that represent the cells 104 are shaped as triangles and labeled ‘BS’ for base station. A given graph 104-1 also represents access links between a UE device and a cell as an edge between two nodes.

In addition to the edges that describe assignments between UE devices 102 and cells 104 as described above, the RAN graphs 204 also include cell-to-cell edges that help the GRL LB agent circuitry 208 capture the interdependent performance across the cells 104 when making LB decisions. In particular, the manager circuitry 202 adds a cell-to-cell edge if there is at least one UE device whose QoS restraints may be satisfied by both cells. Such UE devices are labeled CellEdgeUEs in FIG. 1 because they are geographically located in a region that is approximately equidistant between approximately equidistant between two or more base station devices. For example, in the geographic region of FIG. 1, any of the UE devices 102-2, 102-3, 102-4, 102-5, and 102-6 may be considered CellEdgeUEs. In contrast, the UE devices 102-1 and 102-7 are labelled CellCenterUEs in the RAN graphs 204 because, in their current locations, the QOS requirements of the devices 102-1 and 102-7 are both met by only one cell respectively. Namely, the UE device 120-1 can only be assigned to the cell 104-1 and the UE device 102-7 can only be assigned to the cell 104-3.

The manager circuitry 202 creates multiple RAN graphs 204 by changing the assignments of CellEdgeUEs. In this example, each of the RAN graphs 204 include one potential UE-cell access link. As used above and herein, a potential UE-cell access link describes a hypothetical assignment between a CellEdgeUE and a cell other than the cell it is currently assigned to. For example, if the UE device 102-2 is currently assigned to the cell 104-1 (the existing link), then one of the RAN graphs 204 describes a potential access link between the UE device 102-2 and the cell 104-2 instead of the existing link. In some examples, a potential UE-cell access link is referred to as an action because implementing the potential UE-cell access link requires the manager circuitry 202 to re-assign a UE device to a different cell. Similarly, in some examples, the re-assigned UE device is referred to as a handover UE device.

In some examples, the manager circuitry 202 creates a RAN graph 204-n and corresponding action that represents a proposed initial assignment between the UE device 102 and a cell 104. Thus, such graphs include a potential UE-cell access link but do not remove an existing UE-cell link because the UE device 102 does not have a currently assigned cell when the graph is formed. The manager circuitry 202 may propose such initial assignments in response to determining that a new UE device has joined the wireless network (e.g., has entered the geographic region 100).

The manager circuitry 202 also creates the RAN graphs 204 by maintaining the assignments of CellCenterUEs. For example, each of the RAN graphs 204 includes a) an access link between the UE device 102-1 and the cell 104-1 and b) an access link between the UE device 102-7 and the cell 104-3. The RAN graphs 204 maintain the existing assignments of CellCenterUEs because such access links do not change during LB operations. Notably, an existing access link between a CellCenterUE and its cell can still change if a user moves the UE device to a new location that is on the edge of, or outside of, the range of the cell.

The manager circuitry 202 can use relatively simple techniques (e.g., using received signal strength (RSS) metrics to determine the geographic proximity between a UE device and one or more neighboring cells) to determine that a given UE device (e.g., 102-1) may have its QoS requirements satisfied by multiple cells (e.g., 104-1 or 104-2). However, such simple techniques cannot guarantee or predict with a sufficiently high accuracy that all of the UE-cell edges in all of the RAN graphs 204 would actually satisfy the corresponding QoS requirements of the UE devices 102. Advantageously, the AM agent circuitry 206 is to implement a machine learning model that predicts whether a potential UE-cell access link is admissible or inadmissible. A potential UE-cell access link is admissible if the AM agent circuitry 206 predicts that the corresponding cell will simultaneously satisfy all QoS requirements of its existing UE devices and satisfy the QoS requirements of the new UE device described in the potential access link.

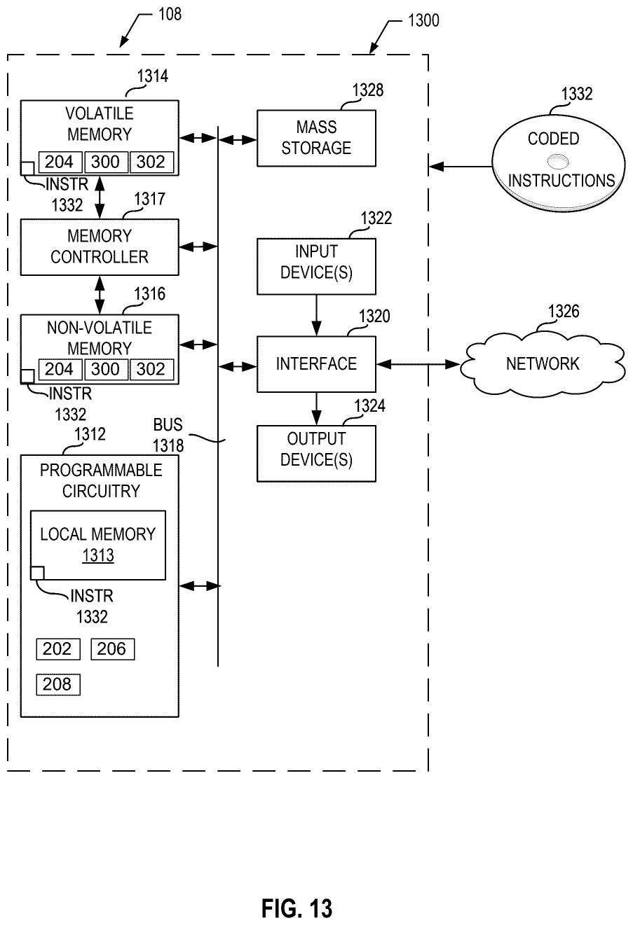

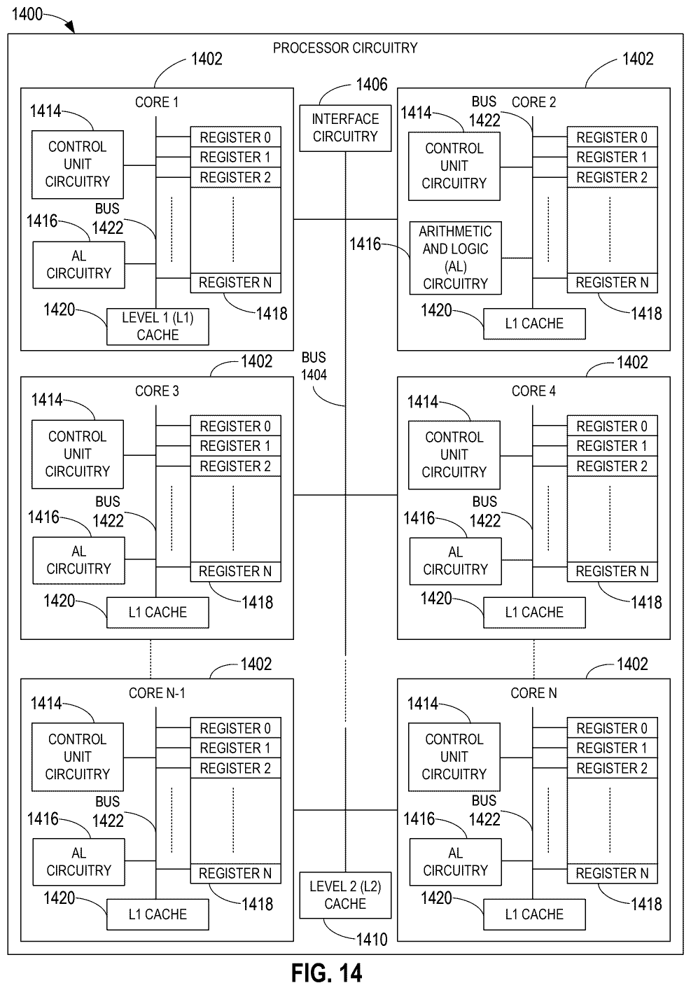

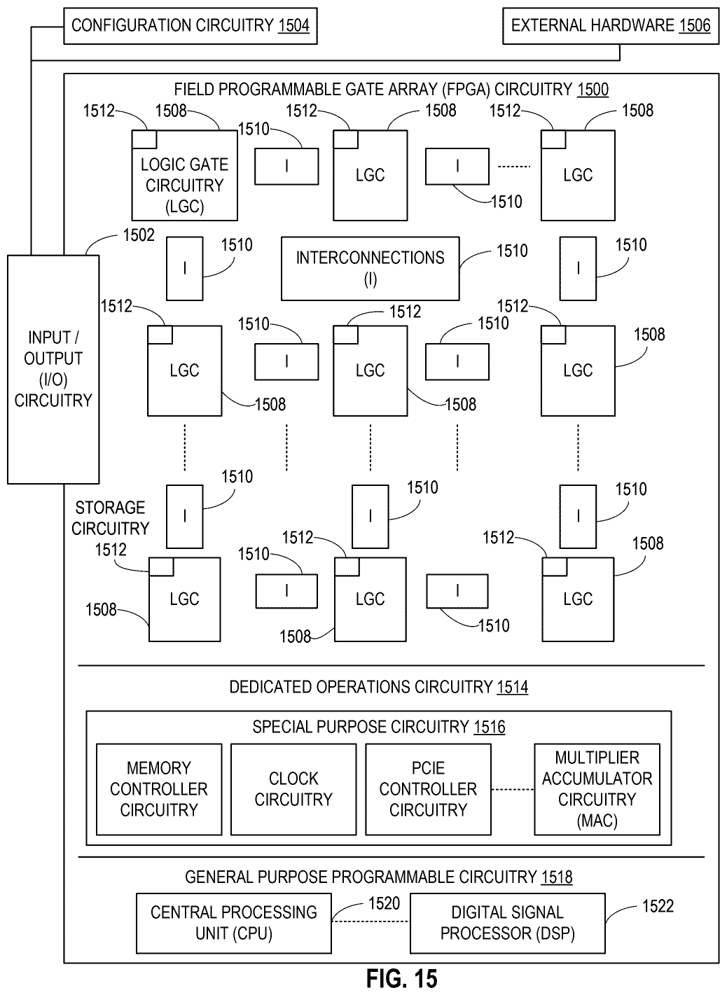

In some examples, the Near-RT RIC circuitry 108 includes means for managing a wireless network. For example, the means for managing may be implemented by manager circuitry 202. In some examples, the manager circuitry 202 may be instantiated by programmable circuitry such as the example programmable circuitry 1312 of FIG. 13. For instance, the manager circuitry 202 may be instantiated by the example microprocessor 1400 of FIG. 14 executing machine executable instructions such as those implemented by at least blocks 502-520 of FIG. 5. In some examples, the manager circuitry 202 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the manager circuitry 202 may be instantiated by any other combination of hardware, software, and/or firmware. For example, the manager circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

By marking some potential UE-cell access links as inadmissible, the AM agent circuitry 206 allows the GRL LB agent circuitry 208 to avoid taking poor actions, particularly during the initial phase of training. The AM agent circuitry 206 also reduces the number of graphs that are processed during inference, as described further below. The AM agent circuitry 206 is described further in connection with FIG. 3. In some examples the AM agent circuitry 206 is implemented by an xApp, which is a type of software component in the O-RAN architecture. More generally, the AM agent circuitry 206 may be instantiated by any type of programmable circuitry executing AM agent instructions and/or configured to perform operations such as those represented by the flowchart(s) of FIGS. 5-8.

In some examples, the Near-RT RIC circuitry 108 includes means for predicting QoS satisfaction. For example, the means for predicting QoS satisfaction may be implemented by AM agent circuitry 206. In some examples, the AM agent circuitry 206 may be instantiated by programmable circuitry such as the example programmable circuitry 1312 of FIG. 13. For instance, the AM agent circuitry 206 may be instantiated by the example microprocessor 1400 of FIG. 14 executing machine executable instructions such as those implemented by at least blocks 508, 602-614, 702-716 of FIGS. 5-7. In some examples, the AM agent circuitry 206 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the AM agent circuitry 206 may be instantiated by any other combination of hardware, software, and/or firmware. For example, the AM agent circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

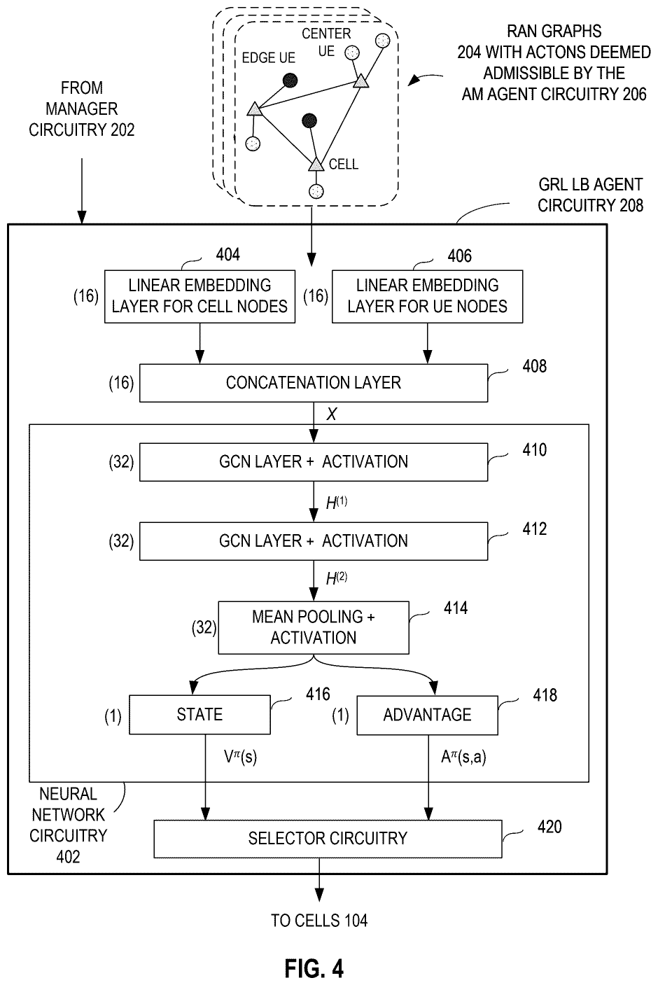

The GRL LB agent circuitry 208 is a QoS aware load balancing agent that selects and implements one of the actions (e.g., deploying one of the graphs 204). The GRL LB agent circuitry 208 can only implement an action if a mask 302 indicates the potential UE-cell access link in the corresponding graph is deemed admissible by the AM agent circuitry 206. To select a graph, the GRL LB agent circuitry 208 is to implement a GNN that determines the effects of handing over one of the CellEdgeUEs from an overloaded cell to an underloaded cell. The GNN offers (a) flexibility to scale to different network sizes regardless of the number of cells 104 or UE devices 102, (b) the ability to extract useful (often lowdimensional) embedding for the RAN while capturing RAN graph structure (i.e., UE-cell connections), and (c) permutation-invariant processing of graph data by aggregating node embeddings, making RAN data processing indifferent to the ordering of cells 104 and UE devices 102. The GRL LB agent circuitry 208 is described further in connection with FIG. 4. In some examples the GRL LB agent circuitry 208 is implemented by an xApp. More generally, the GRL LB agent circuitry 208 is instantiated by any type of programmable circuitry executing GRL LB instructions and/or configured to perform operations such as those represented by the flowchart(s) of FIGS. 5-8.

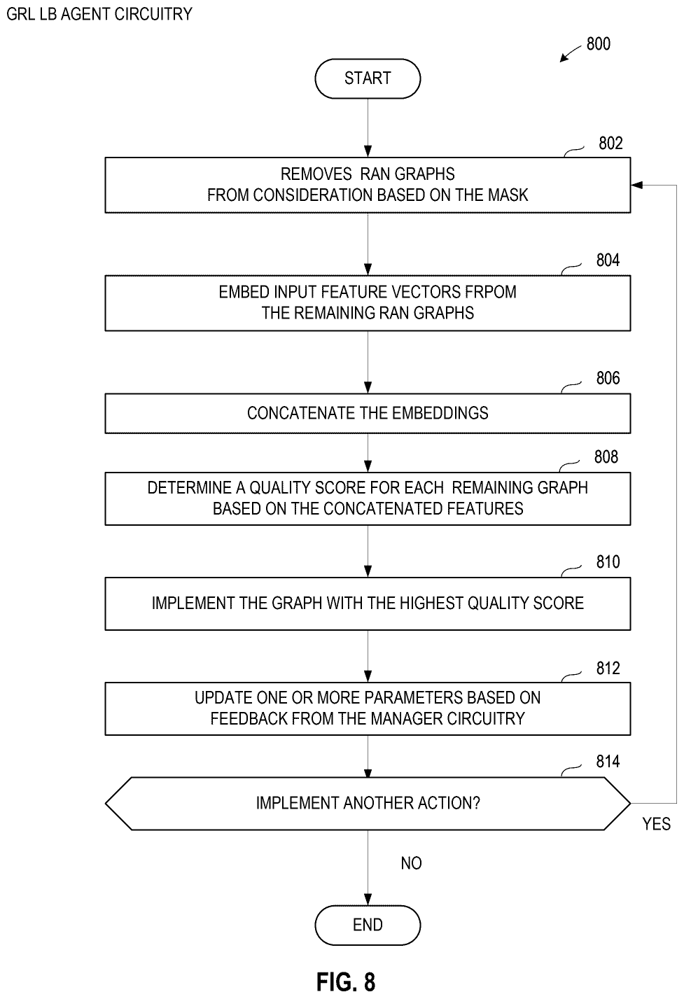

In some examples, the Near-RT RIC circuitry 108 includes means for selecting an action. For example, the means for selecting may be implemented by GRL LB agent circuitry 208. In some examples, the GRL LB agent circuitry 208 may be instantiated by programmable circuitry such as the example programmable circuitry 1312 of FIG. 13. For instance, the GRL LB agent circuitry 208 may be instantiated by the example microprocessor 1400 of FIG. 14 executing machine executable instructions such as those implemented by at least blocks 510, 802-814 of FIGS. 5 and 8. In some examples, the GRL LB agent circuitry 208 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the GRL LB agent circuitry 208 may be instantiated by any other combination of hardware, software, and/or firmware. For example, the GRL LB agent circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of an example implementation of the AM agent circuitry 206 of FIG. 2. FIG. 3 shows the AM agent circuitry 206 includes example exploration circuitry 304, example preconditioning circuitry 306, example embedding and concatenation circuitry 308, and example neural network circuitry 308. FIG. 3 also shows example cell-level graphs 300-1, 300-2, . . . , 300-n (collectively referred to as cell-level graphs 300), an example random mask 302-1, and an example prediction mask 302-2 (collectively referred to as masks 302).

The cell-level graphs 300 are graphs that each includes one potential UE-cell access link. The respective cell-level graphs 300 also include and any existing UE-cell access links associated with the cell that is within the potential UE-cell access link. The cell-level graphs 300 are generated by the manager circuitry 202 with relatively simple techniques to identify CellEdgeUEs graphs (e.g., using RSS as an analog for geographic proximity as described above). The manager circuitry 202 generates the same number of cell-level graphs 300 as RAN graphs 204 (labelled n in FIGS. 2 and 3) because each graph, regardless of size, contains one potential UE-access link.

The masks 302 are data structures that store the outputs of the AM agent circuitry 206. Both masks 302 have one element per cell-level graph 300 (for a total of n elements in FIG. 3). A given element stores a binary value that represents whether the AM agent circuitry 206 considers the corresponding potential UE-cell access link to be admissible. For example, a ‘1’ value in the (1) index of a mask indicates the potential UE-cell access link within graph 206-1 is admissible, while a ‘0’ value in the (1) index indicates the potential UE-cell access link is inadmissible.

During training mode, the exploration circuitry 304 determines whether to a) populate a mask 302-1 by randomly generating binary values or b) populate a mask 302-2 by predicting, with the neural network circuitry 310, which of the potential UE-cell access links in the cell-level graphs 300 are admissible. In the example of FIG. 2, the open state of the switch 305 (which is implemented between the cell-level graphs 300 and the preconditioning circuitry 306) represents a decision by the exploration circuitry 304 to generate a random mask 302-1. Similarly, the closed state of the switch 305 represents a decision by the exploration circuitry 304 to generate a prediction mask 302-2.

The exploration circuitry 304 determines whether to open or close the switch 305 during a given training step using an epsilon-greedy algorithm. In this example, epsilon (the name of the Greek letter ∈) is a value between 1 and 0 that gradually decreases throughout the training process. At any given training step, the exploration circuitry 304 opens the switch 305 and the AM agent circuitry 206 generates a random mask 302-1 (e.g., randomly or pseudo-randomly identifies a subset of potential actions) with probability ∈. Similarly, at any given training step, the exploration circuitry closes the switch 305 and the AM agent circuitry 206 generates a prediction mask 302-2 with probability (1-∈). In other examples, the exploration circuitry 304 uses a different technique to determine whether to open or close the switch 305. During inference mode, the switch 305 remains closed and the AM agent circuitry 206 only generates a mask 302-2 by using the trained machine learning model to predict which of the graphs 204 are admissible.

The exploration circuitry 304 enables training of the machine learning model of FIG. 3 in a contextual multi-arm bandit framework. In general, the contextual multi-arm bandit framework refers to a model training technique where an algorithm chooses between multiple options (arms) to maximize its reward, with each choice informed by the current context or situation. The algorithm learns over time which arm is likely to yield the best outcome based on the context, improving its decisions through a balance of exploring new options and exploiting known rewarding options. For example, randomization is especially relevant during the initial training steps when significant adjustments have not yet been made to the various internal parameters of the machine learning model. During such time, accuracy of the prediction mask 302-2 is relatively low and performance improvements are more likely to occur by trying new model parameters rather than tweaking existing model parameters. Generating a random mask 302-1 increases the probability of larger changes in model parameters. Such large changes can generally be considered as trying new model parameters rather than tweaking existing parameters as described above.

Randomization can also be used sometimes during existing training to avoid a “training rut”. In these situations, randomization forces the machine learning model to consider new model parameters that may perform better than the existing model parameters (despite some amount of previous training that developed the existing parameters). As training continues, e generally decreases and randomization is used less extensively because the model parameters have been adjusted more, resulting in improved prediction accuracy. As used above herein, use of the term “machine learning model” within the context of the AM agent circuitry 206 may refer to one or more of a) the embedding and concatenation circuitry 308 or b) the neural network circuitry 310.

During training steps where the switch 305 is closed and also during inference mode, the manager circuitry 202 obtains RAN data that is used by the preconditioning circuitry 306 to characterize the cell-level graphs 300. In this example, the preconditioning circuitry 306 determines six parameters for each potential UE-cell access link in a given cell-level graph 300-1. These parameters include 1) the delay threshold per packet requirement of the UE device, 2) the average packet size in the cell, 3) the mean packet arrival rate of the cell. 4) the wideband SINR between the UE device and the cell, 5) the current bandwidth utilization rate of the target cell prior to the implementation of the potential access link, and 6) the QOS requirement of the UE device, which defined is as GFBR normalized by MFBR. The preconditioning circuitry 306 also averages the foregoing factors for the existing UE-cell access links in the cell-level graph 300-1. In other examples, the preconditioning circuitry 306 characterizes the cell-level graphs 300.

The embedding and concatenation circuitry 308 expands upon the foregoing factors to capture other characteristics of the cell-level graphs 300 to form vectors of data elements called embeddings. Thus, an embedding may contain other RAN data and/or metadata in addition to the six parameters generated by the preconditioning circuitry 306. Such additional information may include but is not limited to the location of each device in the cell-level graph 300. The embedding and concatenation circuitry 308 then combines (e.g., concatenates) the multiple embeddings into a single matrix of activation values that is interpretable by the neural network circuitry 310.

In FIGS. 3 and 4, embedding layers and concatenation layers are shown outside of the respective neural networks. In other examples, embedding layers and concatenation layers are considered part of the neural networks.

The neural network circuitry 310 manipulates the input matrix by passing elements of the matrix through various layers of weights and activation functions. The final layer of the neural network circuitry 310 generates one scalar value for each of the potential actions (resulting in a total of n scalar values in FIG. 3) and then maps the scalar values, using a Sigmoid function, to decimal values between zero and one. These decimal values are interpreted as cell-level QoS predictions. For example, if a decimal value is close to 1, it is likely that the cell can meet the QoS requirements of the incoming handover UE device and all of its existing UE devices. The AM agent circuitry 206 compares each of the n QOS predictions with a QoS threshold. In this example, the QoS threshold is also a decimal value between zero and one. (e.g., 0.8). The AM agent circuitry 206 adds a ‘1’ to the prediction mask 302-2 if the QoS prediction for the corresponding graph is above the QoS threshold and adds a ‘0’ to the prediction mask 302-2 if the QoS prediction for the corresponding graph is below the QoS threshold.

The neural network circuitry 310 is a fully connected neural network such that every neuron in one layer is connected to every neuron in the subsequent layer. In this example, the output size of each embedding layer is 10, and there are two hidden layers having sizes 16 and 8. In other examples, the neural network 310 has a different number of layers and/or a different number of neurons per layer.

The machine learning model of FIG. 3 is trained by adjusting one or more parameters in a) the embedding and concatenation circuitry 308 and/or b) the neural network circuitry 310 based on feedback from the manager circuitry 202. Such feedback is based on observations from the implementation of one admissible action to the RAN environment of FIG. 1. The feedback is described further in connection with FIG. 5.

FIG. 4 is a block diagram of an example implementation of the GRL LB agent circuitry 208 of FIG. 2. FIG. 4 shows the GRL LB agent circuitry 208 includes example neural network circuitry 402, example embedding layers 404 and 406, an example concatenation layer 408, and example selector circuitry 420. The neural network circuitry 402 includes example activation layers 410, 412, 414, an example state layer 416, and an example advantage layer 418.

The GRL LB agent circuitry 208 performs load balancing as a sequential decision making process that modifies a graph over time by changing UE-to-cell edges. Using such a technique, a decision from the GRL LB agent circuitry 208 to offload a CellEdgeUE u is equivalent to selecting between two graphs that have identical edges except for the two edges that determine cell association for the UE device u. Accordingly, the GRL LB agent circuitry 208 models load balancing operations as a Markov Decision Process (MDP). Here, the state space of the MDP encompasses all feasible RAN graphs 204. The set of actions available to the GRL LB agent circuitry 208 at a given state are a specific subset of RAN graphs 204 that a) differ from the current state by only one potential UE-cell access link and b) is deemed admissible by the AM agent circuitry 206. The policy of the MDP, which informs the GRL LB agent circuitry 208 how to move actions to move between states, is a reward function computed by the manager circuitry 202 and a discount factor that determines how much long-term rewards are valued relative to short-term rewards. The reward function is described further in connection with FIG. 5.

The GRL LB agent circuitry 208 implements the foregoing MDP using to train a deep Q network (DQN). In this example, the neural network circuitry 402 is trained using graph reinforcement learning to predict the value of taking a particular action at a particular state as described further below. In some examples, an equation that predicts the such values of any state within the MDP is referred to as a q-function. Similarly, in some examples, a collection of multiple values may be referred to as a q-table.

To begin either training or inference mode, the GRL LB agent circuitry 208 defines an input feature vector for each node (e.g., each UE device and cell) within the RAN graphs 204 deemed admissible by the AM agent circuitry 206. A given input feature vector characterizes its corresponding node based on measurements of the RAN environment. In this example, the GRL LB agent circuitry 208 defines an input feature vector for a given UE device 102-1 based at least on: 1) a Maximum Flow Bit Rate (MFBR), 2) Guaranteed Flow Bit Rate (GFBR), 3) wideband long-term signal-to-interference-plus-noise ratio (SINR), 4) the average data rate for the UE device 102-1, and 5) the delay budget per packet of the UE device 102-1. Here, MFBR refers to the highest deliverable data rate expected for the QoS of the UE device 102-1. MFBR is generally use-case dependent and therefore varies based on what specific application is currently running on the UE device 102-1. GFBR refers to a data rate below which service is not usable (e.g., the QoS requirements are not met). GFBR is also generally determined based on use-case specific applications. Finally, the delay budget per packet refers to a maximum latency allowed for a packet to travel from the UE device 102-1 to the core network 106 or vice versa. The delay budget per packet is determined based on the QoS requirements for the UE device 102-1 as defined by the 3rd Generation Partnership Project (3GPP) standard. In other examples, the manager circuitry 202 uses a different number and/or different type of RAN metrics to define an input feature vector for a given UE device 102-1.

The GRL LB agent circuitry 208 also creates input feature vector to characterize the cells 104 as described above. In the example of FIG. 2, the input feature vector of a given cell 104-1 includes at least the averaged bandwidth utilization rate of the cell 104-1 and the average number of active UE devices assigned to the cell 104-1. The GRL LB agent circuitry 208 calculates the average bandwidth utilization rate over an observation window defined by a certain number of Transmission Time Intervals (TTIs). A TTI is the smallest unit of time which a cell 104-1 can schedule a UE device 102-1 for uplink or downlink transmission, and, in general, has a duration on the scale of approximately 1 millisecond (ms). In other examples, GRL LB agent circuitry 208 uses a different number and/or different type of RAN metrics to define an input feature vector for a given cell 104-1.

The embedding layers 404 and 406 transform the input feature vectors for the cells 104 and UE devices 102, respectively, into tensors of the same size (e.g., tensors that have the same number of elements). In the example of FIG. 4, both the embedding layers 404 and 406 produce a tensor that has 16 elements per node in an input graph. In other examples, the embedding layers 404 and 406 produce vectors of a different size.

The concatenation layer 408 combines the cell embeddings and the UE embeddings into a single tensor (labelled X in FIG. 4) that is interpretable by the neural network circuitry 402. In the example of FIG. 4, the tensor X has 16 rows. In other examples, the tensor X has a different number of rows.

Within the neural network circuitry 402, the graph convolutional network (GCN) layer 410 transforms the tensor X into the tensor H⁽¹⁾ and the GCN layer 412 transforms the tensor H⁽¹⁾ into the tensor H⁽²⁾. To perform such tensor transformations, both GCN layers 410 and 412 apply various weights to certain values from the input tensor, add ones of the weighted values together, and apply activation functions to the sums. More generally, the GCN layers 410 and 412 perform node-wise feature aggregation based on the graph structure, thereby allowing the LB agent to account for spatial load dependencies across nearby cells. The mean pooling layer then 414 transforms the tensor H⁽²⁾ into another tensor using the foregoing techniques. In doing so, the mean pooling layer 414 performs element-wise averaging over the embeddings of all cell nodes in the graph. In the example of FIG. 4, the tensor H⁽¹⁾, the tensor H⁽²⁾, and the output of the mean pooling layer all have 32 rows. In other examples, one or more of the foregoing tensors have a different number of rows.

The state layer 416 implements the function V″ to transform the output of the mean pooling layer 414 into a single number, V™ (s), that quantifies the strength of the state s. In some examples, the number V^{π}(s) is referred to as a state value. The advantage value implements the function A^{π} to transform the output of the mean pooling layer 414 into a single number, A^{π}(s, a), that quantifies the value or advantage of an action a compared to other actions within a particular state s. In some examples, the number A^{π}(s, a) is referred to as an advantage value. The state value and the action value collectively form the output of the neural network circuitry 402.

The selector circuitry 420 selects, based on the state value and the advantage value, one of the RAN graphs 204 deemed admissible by the AM agent circuitry 206. To do so the selector circuitry 420 uses the state value and the advantage value to generate Q(s, a), a state-action value that quantifies the strength of applying an advantage a to a state s, for each admissible RAN graph 204. The selector circuitry 420 then selects the admissible RAN graph 204 and deploys it to the cells 104.

In this example, FIG. 4 shows the output size of the embedding layers 404 and 406 is 10, the size of the concatenation layer is 10, and there are three hidden layers each having sizes 32. In other examples, the machine learning model of the GRL LB agent circuitry 208 has a different number of layers and/or a different number of neurons per layer.

While an example manner of implementing the Near-RT RIC circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the manager circuitry 202, the AM agent circuitry 206, the GRL LB agent circuitry 208, and/or, more generally, the example Near-RT RIC circuitry 108 of FIG. 2, may be implemented by hardware alone or by hardware in combination with software and/or firmware. Thus, for example, any of the manager circuitry 202, the AM agent circuitry 206, the GRL LB agent circuitry 208, and/or, more generally, the example Near-RT RIC circuitry 108 of FIG. 2, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example Near-RT RIC circuitry 108 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the Near-RT RIC circuitry 108 of FIG. 2 and/or representative of example operations which may be performed by programmable circuitry to implement and/or instantiate the Near-RT RIC circuitry 108 of FIG. 2, are shown in FIGS. 5-8. The machine-readable instructions may be one or more executable programs or portion(s) of one or more executable programs for execution by programmable circuitry such as the programmable circuitry 1312 shown in the example programmable circuitry platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-8, many other methods of implementing the example Near-RT RIC circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, re-assignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to implement the manager circuitry 202. The example machine-readable instructions and/or the example operations 500 of FIG. 5 begin when the manager circuitry 202 assigns the UE devices 102 to the cells 104 randomly (or psuedorandomly). (Block 502). Randomization enables the Near-RT RIC circuitry 108 perform model training as a series of independent episodes that do not influence one another. Episodes are described further below in reference to block 520.

The manager circuitry 202 identifies UE devices on the edges of the range of cells (which are referred to above as CellEdgeUE devices). (Block 504). In some examples, the manager circuitry 202 identifies CellEdgeUE devices by using RSS to determine whether a UE device (e.g. 102-2) is approximately equidistant between two cells (e.g., 104-1 and 104-2). In other examples, the manager circuitry 202 uses a different technique to identify CellEdgeUE devices.

The manager circuitry 202 generates cell-level graphs based on the identified UE devices. (Block 506). Each cell-level graph has one cell from the RAN environment of FIG. 1, the existing UE-cell access links, and one potential UE-cell access link. The potential UE-cell access link represents an association between a CellEdgeUE and a cell that does not currently exist in the RAN environment of FIG. 1.

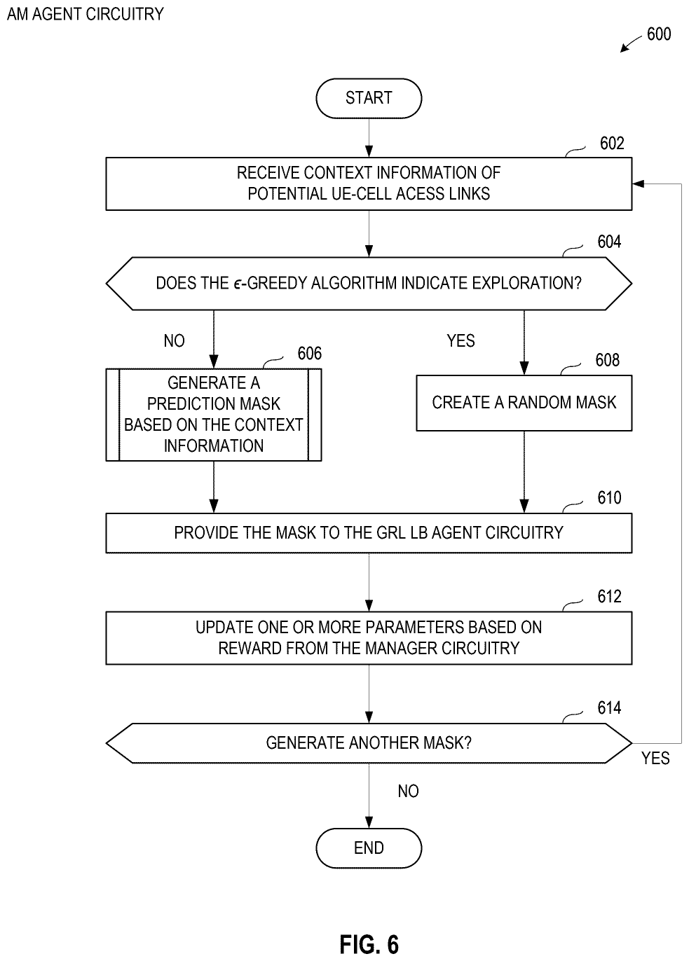

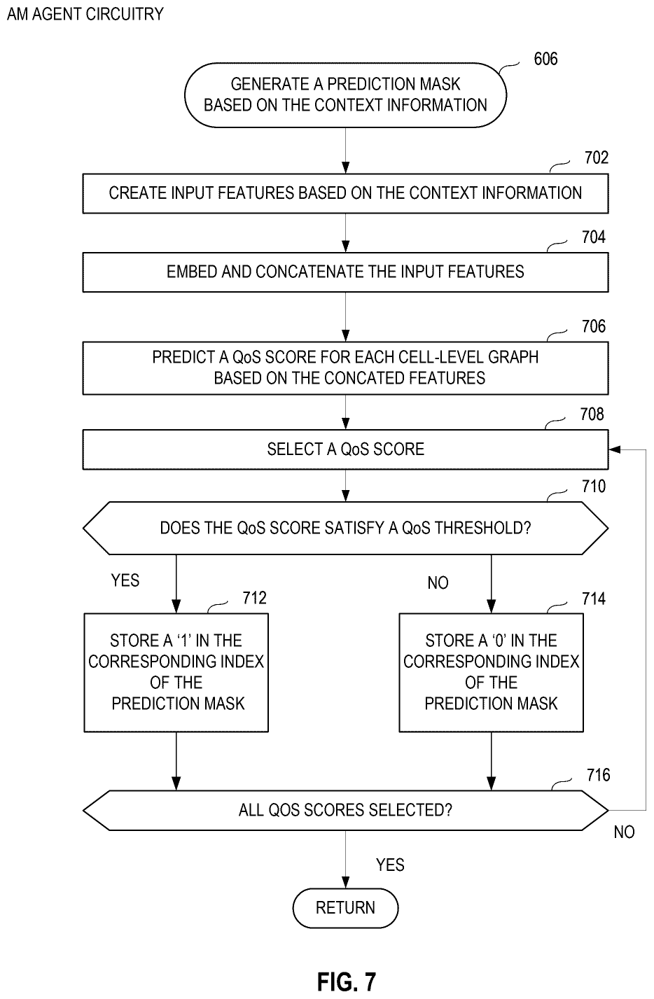

The manager circuitry 202 instructs the AM agent circuitry 206 to generate a mask based on the cell-level graphs. (Block 508). The mask indicates which of the cells the AM agent circuitry 206 predicts can support the addition of the potential UE-cell access links. As described further in FIGS. 6 and 7, the AM agent circuitry 206 uses a first machine learning model to predict which cells can support the addition of the potential UE-cell access links based on the QoS requirements of all UE devices in the cell-level graph.

The manager circuitry 202 instructs the GRL LB agent circuitry 208 to select and implement an action based on the mask. (Block 510). To do so, the GRL LB agent circuitry 208 uses the mask to exclude any of the RAN graphs 204 containing inadmissible potential UE-cell access links. The GRL LB agent circuitry 208 then uses a second machine learning model to select from the remaining RAN graphs and implement the action within the selected graph. Such operations are described further in FIG. 8. In some examples, implementing an action within a selected graph is referred to as deploying the selected graph. By selecting and subsequently deploying a RAN graph, the GRL LB agent circuitry 208 performs load balancing in a manner that considers all UE devices 102 and all cells 104 in the RAN environment of FIG. 1.

The manager circuitry 202 observes the deployment of the selected graph. (Block 512). The manager circuitry 202 performs observations by obtaining one or more measurements from the RAN environment of FIG. 1 after the deployment of the RAN graph at block 510. Such measurements may generate RAN data including but not limited to a) RAN data that supports the six parameters generated by the preconditioning circuitry 306 (as described above in connection with FIG. 3) and b) RAN data that supports the seven metrics used in the RAN graphs 204 to form either a UE input feature vector or cell input feature vector (as described above in connection with FIG. 4). The manager circuitry 202 observes the implemented action for a pre-determined number of TTIs before execution proceeds to block 514.

The manager circuitry 202 provides a reward to the AM agent circuitry 206 based on the observations. (Block 514). The manager circuitry 202 uses the observations to determine a value that quantifies the extent to which the cell that received the handover UE device subsequently fulfilled the corresponding QoS requirements of all UE devices connected to it. In some examples the manager circuitry 202 then calculates Binary Cross-Entropy Loss (BCE), a performance measure for classification models, based on the QOS fulfillment value and provides the BCE as the reward at block 514. In other examples, the manager circuitry 202 uses the QoS fulfillment value to provide a different kind of reward to the AM agent circuitry 206. In some examples, the reward block 514 is referred to as feedback.

The manager circuitry 202 provides a reward to the GRL LB agent circuitry 208 based on the observations. (Block 516). In this example, the reward function of block 516 is defined as the difference between the performance of the RAN before and after the action of block 510. The manager circuitry 202 calculates the performance at either state (e.g., before and after the action) based on two metrics. The first metric is the QoS satisfaction rate as defined by the ratio of Guaranteed Best Rate (GBR) UE devices that meet their QoS to the total number of UE devices that had a QoS based with GBR requirements.

The second metric quantifies the coverage rate of UE devices that use best-effort traffic. As used above and herein, BE traffic refers to network traffic that receives no special treatment or guarantees from the network. Thus, cells 104 handle BE traffic on a first-come, first-served basis, with no prioritization or QoS guarantees. In this example, the manager circuitry 202 defines coverage rate as the fifth percentile of throughput. To do so, the manager circuitry 202 may define the throughput (e.g., in bytes per second) of all the UE devices 102 in the region 100 that use best effort traffic and then sort the values in ascending order. In this example, the coverage rate is the throughput value at which 5% of data is less than or equal to and 95% of values are greater than. In other examples, the manager circuitry 202 uses the observations from block 512 to provide a different kind of reward to the GRL LB agent circuitry 208. In some examples, the reward of block 516 is referred to as feedback. Accordingly, by having the AM agent circuitry 206 and the GRL LB agent circuitry 208 are trained in a feedback loop because a) the output of the AM agent circuitry 206 (the masks 302) is also the input of the GRL LB agent circuitry 208, and b) the manager circuitry 202 provides rewards to both machine learning models after a newly selected action during training mode.

The manager circuitry 202 determines whether to continue training the machine learning models within the AM agent circuitry 206 and GRL LB agent circuitry 208. (Block 518). The manager circuitry 202 may stop or continue model training for any reason. In some examples, the manager circuitry 202 stops training and enters inference mode after a certain number of iterations of the loop of block 506-516, where one action is deployed and both machine learning models receive one reward per iteration. In other examples, manager circuitry 202 stops training and enters inference mode after one or both of the rewards of blocks 514 and 516 satisfy a threshold. The machine-readable instructions and/or operations 500 end if the manager circuitry 202 decides not to continue training (Block 518: No).

In general, the GRL LB agent circuitry 208 can perform load balancing periodically or based on specific events (e.g., movement of a UE device 102-2 causes the UE device 102-2 to be re-assigned to a different cell). Suppose G(0) describes the MDP state of the RAN environment when the manager circuitry 202 instructs the GRL LB agent circuitry 208 to perform load balancing (e.g., the first time the manager circuitry 202 and GRL LB agent circuitry 208 implement block 510). The state of the RAN environment evolves as G(0)→G(1)→ . . . G(m) each time the GRL LB agent circuitry 208 re-executes block 510. As used above and herein, a sequence of load balancing decisions (e.g., a sequence of block 510 implementations) is referred to as an episode. An episode terminates when there are no more feasible actions to take or if the stay action is selected by the GRL LB agent circuitry 208 (e.g., the GRL LB agent circuitry 208 decides not to re-assign any additional CellEdgeUE devices). The length of the episode, m, therefore depends on policy through which a) the GRL LB agent circuitry 208 selects RAN graphs and b) the manager circuitry 202 determines the reward of block 516.

If the manager circuitry 202 decides to continue training (Block 518: Yes), the manager circuitry 202 determines whether the current episode is terminated. (Block 520). If the current episode is not terminated (Block 520: No), control returns to block 506 where the manager circuitry 202 generate new cell-level graphs based on the updated state of the RAN environment. If the current episode is terminated (Block 520: Yes), control returns to block 502 where the manager circuitry 202 randomly re-assigns client devices (e.g., UE devices 102) to cells, thereby starting a new episode where new training paths can be explored.

FIG. 6 is a flowchart representative of example machine-readable instructions and/or example operations that may be executed, instantiated, and/or performed by example programmable circuitry to implement the AM agent circuitry 206 of FIG. 2. The example machine-readable instructions and/or the example operations 600 of FIG. 6 begin when the AM agent circuitry 206 receives context information of potential UE-cell access links. (Block 602). In this example, the context information includes RAN data that enables the preconditioning circuitry 306 to characterize the cell-level graphs 300 as described above.

The AM agent circuitry 206 determines whether the epsilon-greedy algorithm indicates exploration. (Block 604). During training mode, € is a value between 1 and 0 that decreases with each iteration of block 604. Thus, at any given iteration, the epsilon-greedy algorithm indicates exploration (Block 604: Yes) with probability e and does not indicate exploration (Block 604: No) with probability (1-∈). During inference mode, ∈=0 and the epsilon-greedy algorithm does not indicate exploration.

If the epsilon-greedy algorithm does not indicate exploration (Block 604: No), the AM agent circuitry 206 generates a prediction mask 302-2 based on the context information. (Block 606). To do so, the AM agent circuitry 206 executes a machine learning model to predict which of the cell-level graphs 300 would support the QoS requirements of the UE devices if implemented. Block 606 is described further in connection with FIG. 7.

Alternatively, if the epsilon-greedy algorithm does indicate exploration (Block 604: Yes), the AM agent circuitry 206 creates a random mask 302-1. (Block 608). When creating a random mask 302-1, the AM agent circuitry 206 indicates a given cell-level graphs 300-1 is admissible 50% of the time and indicates the graph is inadmissible 50% of the time.

The AM agent circuitry 206 provides the mask of either of blocks 606 or 608 to the GRL LB agent circuitry 208. (Block 610). The AM agent circuitry 206 then updates one or more parameters based on a reward from the manager circuitry 202. (Block 612). As described above at block 512 of FIG. 5, the reward is based on a QoS fulfillment value for one of the cell-level graphs 300 that the AM agent circuitry 206 deemed admissible. To update the one or more parameters of block 612, the AM agent circuitry 206 may change one or more values that adjust how the embedding and concatenation circuitry 308 performs operations and/or change one or more values that adjust how the neural network circuitry 310 performs operations. Such values may influence embedding dimensions, values, or formatting, neural network weights or activation functions, etc. In some examples, the AM agent circuitry 206 only implements block 612 in training mode. In other examples, the AM agent circuitry 206 implements block 612 in both training and inference modes.

The AM agent circuitry 206 determines whether to generate another mask (Block 614). In general, the AM agent circuitry 206 generates another mask as a preliminary operation before the GRL LB agent circuitry 208 performs a load balancing decision. Thus, the AM agent circuitry 206 may generate another mask periodically or in response to a specific event within the RAN environment. The AM agent circuitry 206 makes the determination of block 614 based on instructions from the manager circuitry 202.

If the AM agent circuitry 206 determines to generate another mask (Block 614: Yes), control returns to block 602 where the AM agent circuitry 206 receives additional context information that corresponds to an updated RAN environment (e.g., the context information reflects the action selected and deployed by the GRL LB agent circuitry 208). The machine-readable instructions and/or operations 600 end if the AM agent circuitry 206 does not generate another mask (Block 614: No).

FIG. 7 is a flowchart representative of example machine-readable instructions and/or example operations that may be executed, instantiated, and/or performed by example AM agent circuitry of FIG. 2 to generate a prediction mask based on context information. In particular, the flowchart of FIG. 7 is an example implementation of block 606 of FIG. 6. Execution of block 606 begins when the preconditioning circuitry 306 creates input features based on the context information. (Block 702). In the example of FIG. 3, the input features include: 1) the delay threshold per packet requirement of the UE device, 2) the average packet size in the cell, 3) the mean packet arrival rate of the cell. 4) the wideband SINR between the UE device and the cell, 5) the current bandwidth utilization rate of the target cell prior to the implementation of the potential access link, and 6) the QoS requirement of the UE device, which defined is as GFBR normalized by MFBR. In other examples, the preconditioning circuitry 306 creates different input features at block 702.

The embedding and concatenation circuitry 308 embed and concatenate the input features. (Block 704). The embedding operations add additional data to describe the cell-level graphs 300 and the concatenation operations organize the various embeddings into a single tensor that is interpretable by the neural network circuitry 310.

The neural network circuitry 310 predicts a QoS score for each of the cell-level graphs 300 based on the concatenated features. (Block 706). To do so, the neural network circuitry 310 transforms the concatenated features through multiple layers of weights and activation functions. The output layer of the neural network circuitry 310 has one output neuron per cell-level graph 300. The neural network circuitry 310 passes each value produced by an output neuron into a sigmoid function to create a numbers between 0 and 1. The outputs of the sigmoid functions are the QoS scores of block 706. In some examples, the QoS score is referred to as a confidence level of the neural network circuitry 310.

The AM agent circuitry 206 selects a QoS score. (Block 708). The AM agent circuitry 206 then determines whether the QoS score satisfies a threshold. (Block 710). In this example, the threshold of block 710 if the QoS is greater than or equal to a threshold value (e.g., 0.8). If the QoS score does satisfy the QoS threshold (Block 710: Yes), the AM agent circuitry 206 stores a ‘1’ in the corresponding index of the prediction mask. (Block 712). Alternatively, if the QoS score does not satisfy the threshold (Block 710: No), the AM agent circuitry stores a ‘0’ in the corresponding index of the prediction mask. (Block 714).

The AM agent circuitry 206 determines whether all QoS scores were selected. (Block 716). If all QoS scores were not selected (Block 716: No), control returns to block 708 where the AM agent circuitry 206 selects another QoS score that has not yet been selected. Alternatively, if all QoS scores were selected (Block 716: Yes), control returns to block 610 of FIG. 6.

FIG. 8 is a flowchart representative of example machine-readable instructions and/or example operations that may be executed, instantiated, and/or performed by example programmable circuitry to implement the GRL LB agent circuitry 208 of FIG. 2. The machine-readable instructions and/or operations 800 of FIG. 8 begin when the GRL LB agent circuitry 208 removes RAN graphs 204 for consideration based on the mask of block 606 or 608. (Block 802). As described above, each RAN graph 204 contains one potential UE-access link and therefore represents one re-assignment of a CellEdgeUE device that could be implemented.

The embedding layers 404 and 406 embed input feature vectors from the RAN graphs that remain after the removal of block 802. (Block 804). In the example of FIG. 8, the input feature vectors for a UE node in a RAN graph are 1) MFBR, 2) GFBR, 3) wideband long-term SINR, 4) the average data rate for the UE device, and 5) the delay budget per packet of the UE device. In other examples, the input feature vectors are different. Embedding the input feature vectors transforms the vectors into embeddings, which are tensors of equal size as described above. The concatenation layers 408 then concatenate the embeddings (Block 806) into a single tensor that is interpretable by the neural network circuitry 402.

The neural network circuitry 402 determines a quality score for each of the remaining RAN graphs based on the concatenated features. (Block 808). To do so, the neural network circuitry 402 transforms the concatenated tensor using multiple GCN layers 410, 412 and a mean pooling layer 414. The neural network circuitry 402 then determines a state value V^{π}(s), determines an advantage value A^{π}(s, a), and determines the quality score Q(s, a) as a function of the state value and advantage value.

The GRL LB agent circuitry 208 implements the RAN graph with the highest quality score. (Block 810). To do so, the GRL LB agent circuitry 208 re-assigns, through the core network 106, a UE device from its existing cell to the cell identified in the potential UE-cell access link of the RAN graph with the highest quality score. In some examples, implementing a RAN graph may be referred to as deploying a RAN graph, performing a handover of a UE device, implementing a selected action, or performing a LB decision.

The GRL LB agent circuitry 208 updates one or more internal parameters based on a reward from the manager circuitry 202. (Block 812). The reward is a function of the cell-level QoS, load balancing, and network-wide QoS factors and is defined above at block 516 of FIG. 5. The GRL LB agent circuitry 208 may adjust any number of parameters related to the embedding layers 404 and 406, the concatenation layer 408, or the neural network circuitry 402 based on the reward.

The GRL LB agent circuitry 208 determines whether to implement another action (e.g., whether to make another change to the UE-cell assignments within the RAN environment). (Block 814). The GRL LB agent circuitry 208 may generate another mask periodically or in response to a specific event within the RAN environment as described above. The AM agent circuitry 206 makes the determination of block 814 based on instructions from the manager circuitry 202.

If the GRL LB agent circuitry 208 is to implement another action (Block 814: Yes), control returns to block 802 where the GRL LB agent circuitry 208 removes new RAN graphs 204 from consideration based on a new mask. Alternatively, the machine-readable instructions and/or operations 800 end if the GRL LB agent circuitry 208 does not implement another action (Block 814: No).

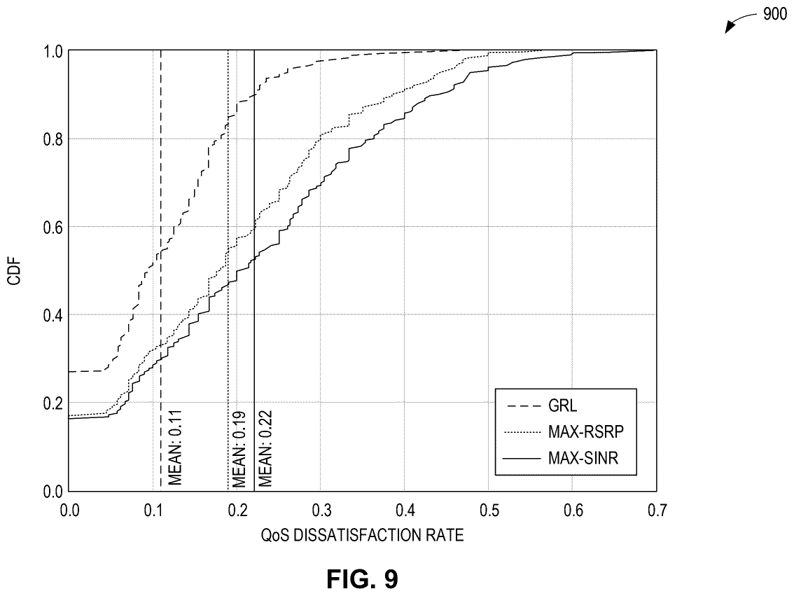

FIGS. 9-13 are graphs illustrating an example performance of the Near-RT RIC circuitry 108 within a simulation that supports 3GPP compliant channel models, non-ideal Channel State Information (CSI) feedback, non-full buffer traffic, link adaptation, Radio Link Control (RLC) re-transmission, and Weighted Proportional Fair (WPF) scheduling. The simulated RAN environment consists of three equidistant cell locations located on a ring at the center of a 1 square kilometer simulation area, with an inter-site distance of 500 meters. Each cell location includes three omni-directional cells 104 (e.g., three base station devices) operating at distinct frequency bands. UE devices 102 are distributed randomly within the simulation area to start each deployment. FIGS. 9-13 compares how the Near-RT RIC circuitry 108 described herein performs in the foregoing simulation to known load balancing techniques that were also simulated in the same environment: (1) maximum Signal-to-Interference-plus-Noise-Ratio (max-SINR), and (2) maximum Reference Signal Received Power (max-RSRP).

FIG. 9 is an example graph 900 that compares the Cumulative Distribution Function (CDF) of the QoS dissatisfaction rate of the GRL based load balancing described herein against the known max-SINR and max-RSRP load balancing techniques. The graph 900 shows the GRL based load balancing techniques had a QoS satisfaction rate of 0.2 or lower approximately 85% of the time, while the max-SINR and max-RSRP maintained a QoS satisfaction rate of 0.2 or less approximately 57% and 47% of the time under the same conditions. More generally, the graph 900 shows the GRL-based LB techniques described herein can minimize the average QOS dissatisfaction rate by 40% compared to the known techniques. The average QOS dissatisfaction rate for the GRL based LB is nonzero in FIG. 9 because the results are obtained for high-traffic network scenarios with an average (post LB) bandwidth utilization of around 60% per cell.

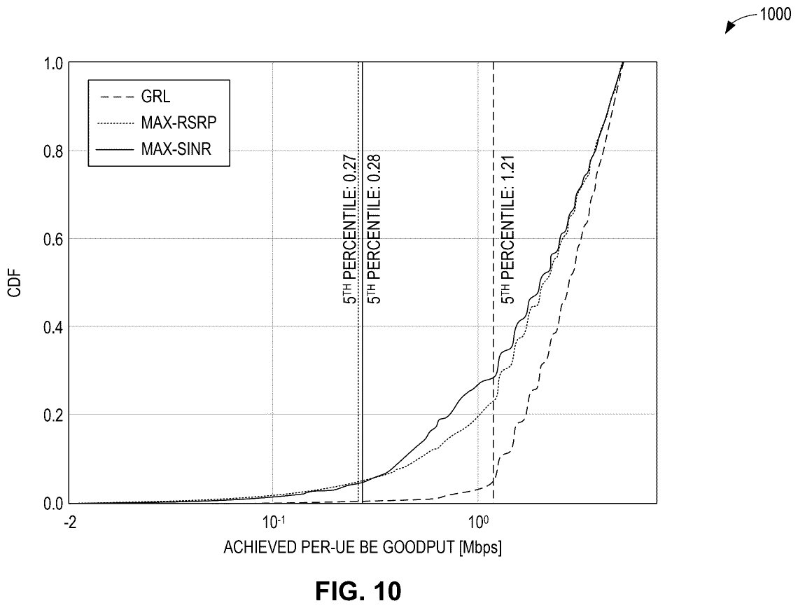

FIG. 10 is an example graph 1000 that compares the CDF of the BE goodput achieved per UE device. As used above and herein, the term “goodput” refers to the rate of useful data transferred, excluding protocol overhead, retransmissions, and other non-payload data. Goodput therefore measures an effective data transfer rate of a system. In contrast, the term “throughput” refers to all data, useful and overhead. The graph 1000 shows that the fifth percentile of simulations performed by GRL-BL achieved a BE goodput of 1.21 Megabits per second (Mbps), while the fifth percentile of simulations by the known max-SINR and max-RSRP load balancing techniques only achieved BE goodputs of 0.27 Mbps and 0.28 Mbps. More generally, the graph 1000 shows the GRL-BL techniques described herein can provide 4.3× better coverage for BE UE devices than known techniques.

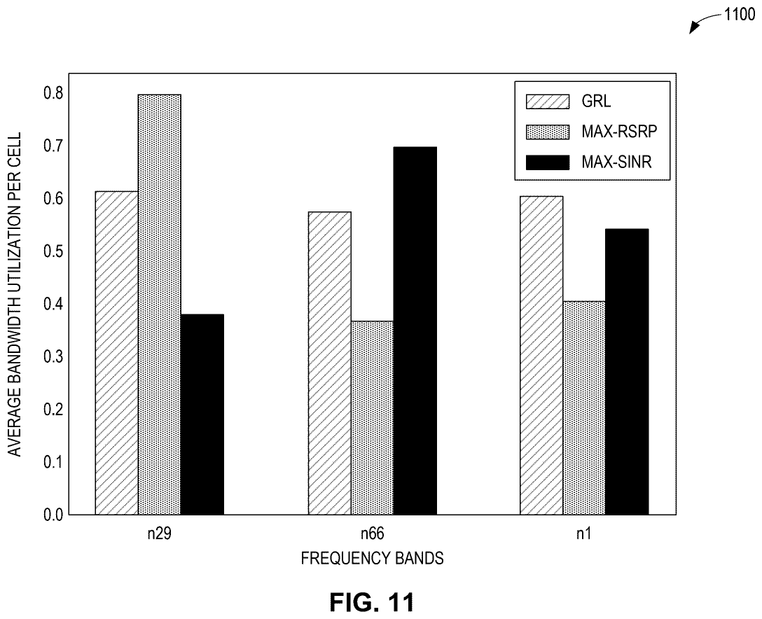

FIG. 11 is an example graph 1100 that compares the average utilization per cell against frequency distribution. In this example, a UE device may be assigned to one of three frequency bands: n29 (which represents a frequency band centered at 725 MegaHertz (MHz) and with a 10 MHz available bandwidth), n66 (which represents a frequency band centered at 2190 MHz and with a 5 MHz available bandwidth), and n1 (which represents a frequency band centered at 2140 MHz and with a 5 MHz available bandwidth). The graph 1100 shows max-RSRP assigns most UE devices to cells at n29 while max-SINR assigns most UE devices to cells at n66. Such known techniques can result in cell congestion at the n29 and n66 bands, respectively, while leaving other bands underutilized. In contrast, the graph 900 shows the GRL-LB technique described herein distributes UE devices approximately equally across the three frequency bands. Accordingly, the GRL-LB technique reduces the standard deviation of per-cell bandwidth utilization rate across all bands by 12% and 16% compared to max-SINR and max-RSRP, respectively.

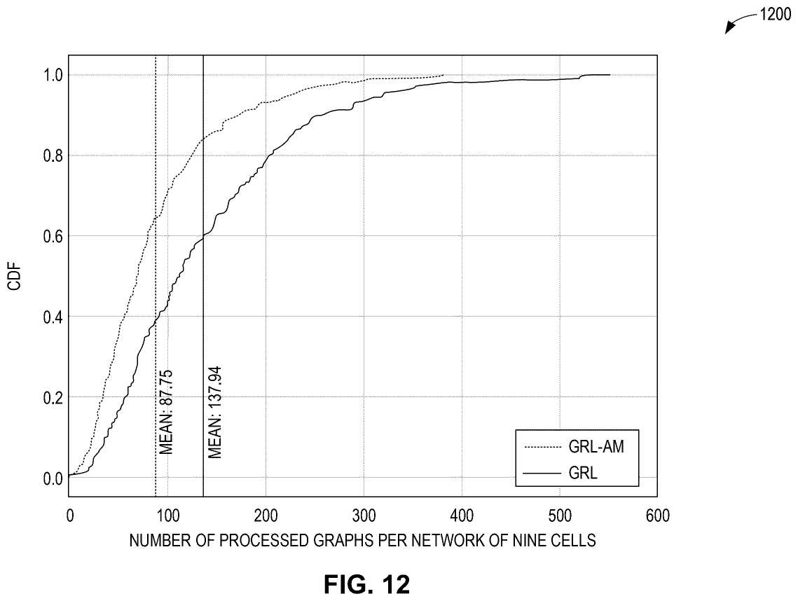

FIG. 12 is an example graph 1200 that compares the CDF of the number of processed graphs per episode for a network of nine cells. The graph 1200 shows that under such conditions, a given episode of training requires the GRL LB agent circuitry 208 to consider an average of 137.94 RAN graphs 204 if the machine learning model is trained by itself. However, in examples described herein, the two machine learning models of the AM agent circuitry 206 and the GRL LB agent circuitry 208 train together in a feedback loop as described above. Using this hierarchal learning approach reduces the average number of processed RAN graphs 204 per episode to 87.75. More generally, the graph 1200 shows the AM agent circuitry 206 can reduce the number of processed graphs by 36% in this example.

FIG. 13 is a block diagram of an example programmable circuitry platform 1300 structured to execute and/or instantiate the example machine-readable instructions and/or the example operations of FIGS. 5-8 to implement the Near-RT RIC circuitry 108 of FIG. 2. The programmable circuitry platform 1300 can be, for example, a server, a personal computer, a workstation, a self-learning machine (e.g., a neural network), a data center, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the manager circuitry 202, the AM agent circuitry 206, and the GRL LB agent circuitry 208.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316. In this example, the main memory 1314, 1316 includes the RAN graphs 204, the cell-level graphs 300, and the masks 302.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 5-8, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 5-8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 5-8.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 142 may be referred to as a CPU, DSP, GPU, etc., or any other type of hardware circuitry. Each core 142 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 142 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 142. The AL circuitry 1416 includes semiconductor-based circuits structured to perform one or more mathematic and/or logic operations on the data within the corresponding core 142. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 142. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 142 to shorten access time. The second bus 1422 may be implemented by at least one of an I2C bus, a SPI bus, a PCI bus, or a PCIe bus.

Each core 142 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 5-8 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-8. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-8. As such, the FPGA circuitry 1500 may be configured and/or structured to effectively instantiate some or all of the operations/functions corresponding to the machine-readable instructions of the flowchart(s) of FIGS. 5-8 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 5-8 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 5-8 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIGS. 5-8 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIGS. 5-8, and/or an ASIC may be configured and/or structured to perform third operation(s)/function(s) corresponding to a third portion of the machine-readable instructions represented by the flowcharts of FIGS. 5-8.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

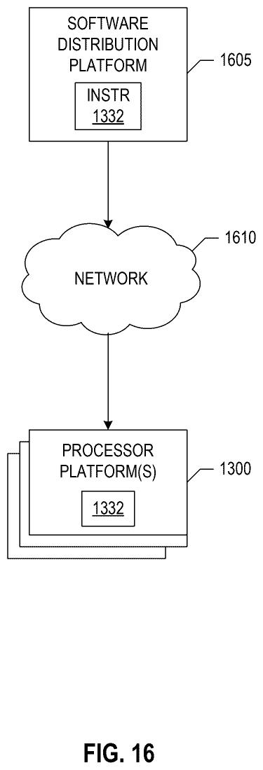

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 5-8, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIGS. 5-8, may be downloaded to the example programmable circuitry platform 1300, which is to execute the machine-readable instructions 1332 to implement the Near-RT RIC circuitry 108. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform load balancing in a manner that improves GBR and BE traffic performance in a multi-band O-RAN under QoS and resource constraints. Disclosed systems, apparatus, articles of manufacture, and methods improve the efficiency of using a computing device by implementing a first machine learning model that uses contextual bandit techniques to mask (e.g., exclude) actions by predicting the cell-level QoS fulfillment rate if the action is implemented, and by implementing a second machine learning model that uses GRL techniques to implement a DQN that selects and deploys, based on the state of the entire RAN environment, an action that is not masked by the first machine learning model. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to for quality-of-service aware load balancing in wireless networks are disclosed herein. Further examples and combinations thereof include the following.

Example 1 includes an apparatus to perform load balancing in a wireless network, the apparatus comprising interface circuitry, machine-readable instructions, and programmable circuitry to at least one of instantiate or execute the machine-readable instructions to generate potential actions to, if implemented, re-assign a client device in the wireless network from a first base station device in the wireless network to another base station device in the wireless network, wherein the re-assignment is to cause the first base station device to stop communications with the client device and is to cause the another base station device to begin communications with the client device, execute a first machine learning model to predict which of the potential actions would satisfy a quality of service (QOS) threshold, execute a second machine learning model to select one of the potential actions predicted to satisfy the QoS threshold, and implement the selected action within the wireless network.

Example 2 includes the apparatus of example 1, wherein the first machine learning model includes a contextual multi-armed bandit agent that is to implement a neural network.

Example 3 includes the apparatus of one or more of examples 1-2, wherein to execute the first machine learning model, the programmable circuitry is to use the neural network to generate a scalar value for one or more potential actions, use a sigmoid function to map scalar values to decimal values between zero and one, and determine whether a scalar value associated with a given graph is greater or equal to the QoS threshold.

Example 4 includes the apparatus of one or more of examples 1-3, wherein the programmable circuitry is to train the first machine learning model with deep learning.

Example 5 includes the apparatus of one or more of examples 1-4, wherein the second machine learning model is a QoS aware load balancing agent that is to implement a Graph Neural Network.

Example 6 includes the apparatus of one or more of examples 1-5, wherein the programmable circuitry is to train the second machine learning model via Graph Reinforcement Learning as a deep Q network (DQN) agent.

Example 7 includes the apparatus of one or more of examples 1-6, wherein the programmable circuitry is to train the first machine learning model and the second machine learning model together in a feedback loop.

Example 8 includes the apparatus of one or more of examples 1-7, wherein to execute the second machine learning model, the programmable circuitry is to generate a quality score for one or more of the potential actions predicted to satisfy the QoS threshold, and select an action based on the one or more quality scores.

Example 9 includes the apparatus of one or more of examples 1-8, wherein to generate a quality score, the programmable circuitry is to determine a state value that characterizes a given state of the wireless network, determine an advantage value that characterizes one action relative to other actions within the given state, and determine the quality score as a function of the state value and the advantage value.

Example 10 includes the apparatus of one or more of examples 1-9, wherein the programmable circuitry is to adjust one of more of the first machine learning model and the second machine learning model based on Radio Access Network (RAN) data measured at the wireless network after the selected action is implemented.

Example 11 includes the apparatus of one or more of examples 1-10, wherein to adjust the first machine learning model, the programmable circuitry is to determine a reward based on whether the RAN data satisfies the QoS threshold.

Example 12 includes the apparatus of one or more of examples 1-11, wherein to adjust the second machine learning model, the programmable circuitry is to determine a reward based on a) a QoS satisfaction rate and b) a coverage rate of best-effort traffic from client devices in the wireless network.

Example 13 includes the apparatus of one or more of examples 1-12, wherein the potential actions are first potential actions based on a first state of the wireless network, the implementation of the selected action is to move the wireless network to a second state, and the programmable circuitry is to generate second potential actions based on the second state of the wireless network, execute the adjusted first machine learning model to predict which of the second potential actions would satisfy the QoS threshold, execute the adjusted second machine learning model to select one of the second potential actions predicted to satisfy the QoS threshold, and implement the newly selected action.

Example 14 includes the apparatus of one or more of examples 1-13, wherein the potential actions are first potential actions based on a first state of the wireless network, the implementation of the selected action is to move the wireless network to a second state, and the programmable circuitry is to generate second potential actions based on the second state of the wireless network, randomly or pseudo-randomly identify ones of the second potential actions, execute the second machine learning model to select one of the randomly or pseudo-randomly identified actions, and implement the newly selected action.

Example 15 includes the apparatus of one or more of examples 1-14, wherein the programmable circuitry is to execute an epsilon-greedy algorithm to determine when to randomly or pseudo-randomly identify a subset of potential actions and when to predict which of the potential actions satisfy the QoS threshold.

Example 16 includes the apparatus of one or more of examples 1-15, wherein the potential actions are first potential actions based on a first state of the wireless network, the implementation of the selected action is to move the wireless network to a second state, and the programmable circuitry is to randomly or pseudo-randomly re-assign client devices to base station devices to move the wireless network to a third state, and generate second potential actions based on the third state of the wireless network.

Example 17 includes the apparatus of one or more of examples 1-16, wherein to generate the potential actions, the programmable circuitry is to identify client devices that are approximately equidistant between two or more base station devices.

Example 18 includes the apparatus of example 1, wherein the client device is a first client device, the potential actions are first potential actions corresponding to a first client device, and the programmable circuitry is to generate second potential actions to, if implemented, create an initial assignment between a second client device and a base station device in the wireless network.

Example 19 includes a non-transitory machine-readable storage medium comprising instructions to cause programmable circuitry to at least generate potential actions to, if implemented, re-assign a client device in a wireless network from a first base station device in the wireless network to another base station device in the wireless network, wherein the re-assignment is to cause the first base station device to stop communications with the client device and is to cause the another base station device to begin communications with the client device, execute a first machine learning model to predict which of the potential actions would satisfy a quality of service (QOS) threshold, execute a second machine learning model to select one of the potential actions predicted to satisfy the QoS threshold, and implement the selected action within the wireless network.

Example 20 includes the non-transitory machine-readable storage medium of one or more of examples 18-19, wherein the first machine learning model includes a contextual multi-armed bandit agent that is to implement a neural network.

Example 21 includes the non-transitory machine-readable storage medium of one or more of examples 18-20, wherein to execute the first machine learning model, the instructions cause the programmable circuitry to use the neural network to generate a scalar value for one or more of the potential actions, use a sigmoid function to map scalar values to decimal values between zero and one, and determine whether a scalar value associated with a given graph is greater or equal to the QoS threshold.

Example 22 includes the non-transitory machine-readable storage medium of one or more of examples 18-21, wherein the instructions cause the programmable circuitry to train the first machine learning model with deep learning.

Example 23 includes the non-transitory machine-readable storage medium of one or more of examples 18-22, wherein the second machine learning model is a QoS aware load balancing agent that is to implement a Graph Neural Network.

Example 24 includes the non-transitory machine-readable storage medium of one or more of examples 18-23, wherein the instructions cause the programmable circuitry to train the second machine learning model via Graph Reinforcement Learning as a deep Q network (DQN) agent.

Example 25 includes the non-transitory machine-readable storage medium of one or more of examples 18-24, wherein the instructions cause the programmable circuitry to train the first machine learning model and the second machine learning model together in a feedback loop.

Example 26 includes the non-transitory machine-readable storage medium of one or more of examples 18-25, wherein to execute the second machine learning model, the instructions cause the programmable circuitry to generate a quality score for one or more of the potential actions predicted to satisfy the QoS threshold, and select an action based on the one or more quality scores.

Example 27 includes the non-transitory machine-readable storage medium of one or more of examples 18-26, wherein to generate a quality score, the instructions cause the programmable circuitry to determine a state value that characterizes a given state of the wireless network, determine an advantage value that characterizes one action relative to other actions within the given state, and determine the quality score as a function of the state value and the advantage value.

Example 28 includes the non-transitory machine-readable storage medium of one or more of examples 18-27, wherein the instructions cause the programmable circuitry to adjust one of more of the first machine learning model and the second machine learning model based on Radio Access Network (RAN) data generated by the wireless network after the selected action is implemented.

Example 29 includes the non-transitory machine-readable storage medium of one or more of examples 18-28, wherein to adjust the first machine learning model, the instructions cause the programmable circuitry to perform operations that include determining a reward based on whether the RAN data satisfies the QoS threshold.

Example 30 includes the non-transitory machine-readable storage medium of one or more of examples 18-29, wherein to adjust the second machine learning model, the instructions cause the programmable circuitry to perform operations that include determining a reward based on a) a QoS satisfaction rate and b) a coverage rate of best-effort traffic from client devices in the wireless network.

Example 31 includes the non-transitory machine-readable storage medium of one or more of examples 18-30, wherein the potential actions are first potential actions based on a first state of the wireless network, the implementation of the selected action is to move the wireless network to a second state, and the instructions cause the programmable circuitry to generate second potential actions based on the second state of the wireless network, execute the adjusted first machine learning model to predict which of the second potential actions would satisfy the QoS threshold, execute the adjusted second machine learning model to select one of the second potential actions predicted to satisfy the QoS threshold, and implement the newly selected action.

Example 32 includes the non-transitory machine-readable storage medium of one or more of examples 18-31, the potential actions are first potential actions based on a first state of the wireless network, the implementation of the selected action is to move the wireless network to a second state, and the instructions cause the programmable circuitry to generate second potential actions based on the second state of the wireless network, randomly or pseudo-randomly identify ones of the second potential actions, execute the second machine learning model to select one of the randomly or pseudo-randomly identified actions, and implement the newly selected action.

Example 33 includes the non-transitory machine-readable storage medium of one or more of examples 18-32, wherein the programmable circuitry is to, during training, execute an epsilon-greedy algorithm to determine when to randomly or pseudo-randomly identify a subset of potential actions and when to predict which of the potential actions satisfy the QoS threshold.

Example 34 includes the non-transitory machine-readable storage medium of one or more of examples 18-33, wherein the potential actions are first potential actions based on a first state of the wireless network, the implementation of the selected action is to move the wireless network to a second state, and the instructions cause the programmable circuitry to randomly or pseudo-randomly re-assign client devices to base station devices to move the wireless network to a third state, and generate second potential actions based on the third state of the wireless network.

Example 35 includes the non-transitory machine-readable storage medium of one or more of examples 18-34, wherein to generate the potential actions, the instructions cause the programmable circuitry to identify client devices that are approximately equidistant between two or more base station devices.

Example 36 includes the non-transitory machine-readable storage medium of one or more of examples 18-35, wherein the client device is a first client device, the potential actions are first potential actions corresponding to a first client device, and the instructions cause the programmable circuitry to generate second potential actions to, if implemented, create an initial assignment between a second client device and a base station device in the wireless network.

Example 37 includes an apparatus to perform load balancing, the apparatus comprising means for managing a wireless network to generate potential actions to, if implemented, re-assign a client device in the wireless network from a first base station device in the wireless network to another base station device in the wireless network, wherein the re-assignment is to cause the first base station device to stop communications with the client device and is to cause the another base station device to begin communications with the client device, means for predicting to execute a first machine learning model to predict which of the potential actions would satisfy a quality of service (QOS) threshold, and means for selecting to execute a second machine learning model to select one of the potential actions predicted to satisfy the QoS threshold, and implement the selected action within the wireless network.

Example 38 includes the apparatus of one or more of examples 37, wherein the first machine learning model includes a contextual multi-armed bandit agent that is to implement a neural network.

Example 39 includes the apparatus of one or more of examples 37-38, wherein to execute the first machine learning model, the means for predicting is to use the neural network to generate a scalar value for one or more of the potential actions, use a sigmoid function to map scalar values to decimal values between zero and one, and determine whether a scalar value associated with a given graph is greater or equal to the QoS threshold.

Example 40 includes the apparatus of one or more of examples 37-39, wherein the means for managing is to train the first machine learning model with deep learning.

Example 41 includes the apparatus of one or more of examples 37-40, wherein the second machine learning model is a QoS aware load balancing agent that is to implement a Graph Neural Network.

Example 42 includes the apparatus of one or more of examples 37-41, wherein the means for managing is to train the second machine learning model via Graph Reinforcement Learning as a deep Q network (DQN) agent.

Example 43 includes the apparatus of one or more of examples 37-42, wherein the means for managing is to train the first machine learning model and the second machine learning model together in a feedback loop.

Example 44 includes the apparatus of one or more of examples 37-43, wherein to execute the second machine learning model, the means for selecting is to generate a quality score for one or more of the potential actions predicted to satisfy the QoS threshold, and select an action based on the one or more quality scores.

Example 45 includes the apparatus of one or more of examples 37-44, wherein to generate a quality score, the means for selecting is to determine a state value that characterizes a given state of the wireless network, determine an advantage value that characterizes one action relative to other actions within the given state, and determine the quality score as a function of the state value and the advantage value.

Example 46 includes the apparatus of one or more of examples 37-45, wherein the means for predicting is to adjust one the first machine learning model and the means for selecting is to adjust the second machine learning model based on Radio Access Network (RAN) data measured at the wireless network after the selected action is implemented.

Example 47 includes the apparatus of one or more of examples 37-46, wherein the means for managing is to determine a reward based on whether the RAN data satisfies the QoS threshold, and the means for predicting is to adjust the first machine learning model based on the reward.

Example 48 includes the apparatus of one or more of examples 37-47, wherein the means for managing is to determine a reward based on a) a QoS satisfaction rate and b) a coverage rate of best-effort traffic from client devices in the wireless network, and the means for selecting is to adjust the second machine learning model based on the reward.

Example 49 includes the apparatus of one or more of examples 37-48, wherein the potential actions are first potential actions based on a first state of the wireless network, the implementation of the selected action is to move the wireless network to a second state, the means for managing is to generate second potential actions based on the second state of the wireless network, the means for predicting is to execute the adjusted first machine learning model to predict which of the second potential actions would satisfy the QoS threshold, and the means for selecting is to execute the adjusted second machine learning model to select one of the second potential actions predicted to satisfy the QoS threshold, and implement the newly selected action.

Example 50 includes the apparatus of one or more of examples 37-49, wherein the potential actions are first potential actions based on a first state of the wireless network, the implementation of the selected action is to move the wireless network to a second state, the means for managing is to generate second potential actions based on the second state of the wireless network, the means for predicting is to randomly or pseudo-randomly identify ones of the second potential actions, and the means for selecting is to execute the second machine learning model to select one of the randomly or pseudo-randomly identified actions, and implement the newly selected action.

Example 51 includes the apparatus of one or more of examples 37-50, wherein the means for predicting is to execute an epsilon-greedy algorithm to determine when to randomly or pseudo-randomly identify a subset of potential actions and when to predict which of the potential actions satisfy the QoS threshold.

Example 52 includes the apparatus of one or more of examples 37-51, wherein the potential actions are first potential actions based on a first state of the wireless network, the implementation of the selected action is to move the wireless network to a second state, and the means for managing is to randomly or pseudo-randomly re-assign client devices to base station devices to move the wireless network to a third state, and generate second potential actions based on the third state of the wireless network.

Example 53 includes the apparatus of one or more of examples 37-52, wherein to generate the potential actions, the means for managing is to identify client devices that are approximately equidistant between two or more base station devices.

Example 54 includes the apparatus of one or more of examples 37-53, wherein the client device is a first client device, the potential actions are first potential actions corresponding to a first client device, and the means for managing is to generate second potential actions to, if implemented, create an initial assignment between a second client device and a base station device in the wireless network.

Example 55 includes a method to perform load balancing in a network, the method comprising generating potential actions to, if implemented, re-assign a client device in a wireless network from a first base station device in the wireless network to another base station device in the wireless network, wherein the re-assignment is to cause the first base station device to stop communications with the client device and is to cause the another base station device to begin communications with the client device, executing a first machine learning model to predict which of the potential actions would satisfy a quality of service (QOS) threshold, executing a second machine learning model to select one of the potential actions predicted to satisfy the QoS threshold, and implementing the selected action within the wireless network.

Example 56 includes the method of one or more of examples 55, wherein the first machine learning model is a contextual multi-armed bandit agent that is to implement a neural network.

Example 57 includes the method of one or more of examples 55-56, wherein executing the first machine learning model includes generating, using the neural network, a scalar value for one or more of the potential actions, mapping, using a sigmoid function, scalar values to decimal values between zero and one, and determining whether a scalar value associated with a given graph is greater or equal to the QoS threshold.

Example 58 includes the method of one or more of examples 55-57, including training the first machine learning model with deep learning.

Example 59 includes the method of one or more of examples 55-58, wherein the second machine learning model is a QoS aware load balancing agent that is to implement a Graph Neural Network.

Example 60 includes the method of one or more of examples 55-59, including training train the second machine learning model via Graph Reinforcement Learning as a deep Q network (DQN) agent.

Example 61 includes the method of one or more of examples 55-60, including training the first machine learning model and the second machine learning model together in a feedback loop.

Example 62 includes the method of one or more of examples 55-61, wherein executing the second machine learning model includes generating a quality score for one or more of the potential actions predicted to satisfy the QoS threshold, and selecting an action based on the one or more quality scores.

Example 63 includes the method of one or more of examples 55-62, wherein generating a quality score includes determining a state value that characterizes a given state of the wireless network, determining an advantage value that characterizes one action relative to other actions within the given state, and determining the quality score as a function of the state value and the advantage value.

Example 64 includes the method of one or more of examples 55-63, including adjusting one of more of the first machine learning model and the second machine learning model based on Radio Access Network (RAN) data measured at the wireless network after the selected action is implemented.

Example 65 includes the method of one or more of examples 55-64, wherein adjusting the first machine learning model includes determining a reward based on whether the RAN data satisfies the QoS threshold.

Example 66 includes the method of one or more of examples 55-65, wherein adjusting the second machine learning model includes determining a reward based on a) a QoS satisfaction rate and b) a coverage rate of best-effort traffic from client devices in the wireless network.

Example 67 includes the method of one or more of examples 55-66, wherein the potential actions are first potential actions based on a first state of the wireless network, the implementation of the selected action moves the wireless network to a second state, and the method includes generating second potential actions based on the second state of the wireless network, executing the adjusted first machine learning model to predict which of the second potential actions would satisfy the QoS threshold, executing the adjusted second machine learning model to select one of the second potential actions predicted to satisfy the QoS threshold, and implementing the newly selected action.

Example 68 includes the method of one or more of examples 55-67, wherein the potential actions are first potential actions based on a first state of the wireless network, the implementation of the selected action moves the wireless network to a second state, and the method includes generating second potential actions based on the second state of the wireless network, randomly identifying ones of the second potential actions, executing the second machine learning model to select one of the randomly identified actions, and implementing the newly selected action.

Example 69 includes the method of one or more of examples 55-68, including executing an epsilon-greedy algorithm to determine when to randomly identify a subset of potential actions and when to predict which of the potential actions satisfy the QoS threshold by executing the first machine learning model.

Example 70 includes the method of one or more of examples 55-69, wherein the potential actions are first potential actions based on a first state of the wireless network, the implementation of the selected action moves the wireless network to a second state, and the method includes randomly re-assigning client devices to base station devices to move the wireless network to a third state, and generating second potential actions based on the third state of the wireless network.

Example 71 includes the method of one or more of examples 55-70, wherein generating the potential actions includes identifying client devices that are approximately equidistant between two or more base station devices.

Example 72 includes the method of one or more of examples 55-71, wherein the client device is a first client device, the potential actions are first potential actions corresponding to a first client device, and the method includes generating second potential actions, to, if implemented, create an initial assignment between a second client device that has joined the wireless network and a base station device in the wireless network.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to perform load balancing in a wireless network, the apparatus comprising:
interface circuitry;
machine-readable instructions; and
programmable circuitry to at least one of instantiate or execute the machine-readable instructions to:
generate potential actions to, if implemented, re-assign a client device in the wireless network from a first base station device in the wireless network to another base station device in the wireless network, wherein the re-assignment is to cause the first base station device to stop communications with the client device and is to cause the another base station device to begin communications with the client device;
execute a first machine learning model to predict which of the potential actions would satisfy a quality of service (QOS) threshold;
execute a second machine learning model to select one of the potential actions predicted to satisfy the QoS threshold; and
implement the selected action within the wireless network.

2. The apparatus of claim 1, wherein to execute the first machine learning model, the programmable circuitry is to:
use a neural network to generate a scalar value for one or more potential actions;
use a sigmoid function to map scalar values to decimal values between zero and one; and
determine whether a scalar value associated with a given graph is greater or equal to the QoS threshold.

3. A non-transitory machine-readable storage medium comprising instructions to cause programmable circuitry to at least:
generate potential actions to, if implemented, re-assign a client device in a wireless network from a first base station device in the wireless network to another base station device in the wireless network, wherein the re-assignment is to cause the first base station device to stop communications with the client device and is to cause the another base station device to begin communications with the client device;
execute a first machine learning model to predict which of the potential actions would satisfy a quality of service (QOS) threshold;
execute a second machine learning model to select one of the potential actions predicted to satisfy the QoS threshold; and
implement the selected action within the wireless network.

4. The non-transitory machine-readable storage medium of claim 3, wherein the first machine learning model includes a contextual multi-armed bandit agent that is to implement a neural network.

5. The non-transitory machine-readable storage medium of claim 4, wherein to execute the first machine learning model, the instructions cause the programmable circuitry to:
use the neural network to generate a scalar value for one or more of the potential actions;
use a sigmoid function to map scalar values to decimal values between zero and one; and
determine whether a scalar value associated with a given graph is greater or equal to the QoS threshold.

6. The non-transitory machine-readable storage medium of claim 3, wherein the instructions cause the programmable circuitry to train the first machine learning model with deep learning.

7. The non-transitory machine-readable storage medium of claim 3, wherein the second machine learning model is a QoS aware load balancing agent that is to implement a Graph Neural Network.

8. The non-transitory machine-readable storage medium of claim 3, wherein the instructions cause the programmable circuitry to train the second machine learning model via Graph Reinforcement Learning as a deep Q network (DQN) agent.

9. The non-transitory machine-readable storage medium of claim 3, wherein the instructions cause the programmable circuitry to train the first machine learning model and the second machine learning model together in a feedback loop.

10. The non-transitory machine-readable storage medium of claim 3, wherein to execute the second machine learning model, the instructions cause the programmable circuitry to:
generate a quality score for one or more of the potential actions predicted to satisfy the QoS threshold; and
select an action based on the one or more quality scores.

11. The non-transitory machine-readable storage medium of claim 10, wherein to generate a quality score, the instructions cause the programmable circuitry to:
determine a state value that characterizes a given state of the wireless network;
determine an advantage value that characterizes one action relative to other actions within the given state; and
determine the quality score as a function of the state value and the advantage value.

12. The non-transitory machine-readable storage medium of claim 3, wherein the instructions cause the programmable circuitry to adjust one of more of the first machine learning model and the second machine learning model based on Radio Access Network (RAN) data generated by the wireless network after the selected action is implemented.

13. The non-transitory machine-readable storage medium of claim 12, wherein to adjust the first machine learning model, the instructions cause the programmable circuitry to determine a reward based on whether the RAN data satisfies the QoS threshold.

14. The non-transitory machine-readable storage medium of claim 12, wherein to adjust the second machine learning model, the instructions cause the programmable circuitry to determine a reward based on a) a QoS satisfaction rate and b) a coverage rate of best-effort traffic from client devices in the wireless network.

15. The non-transitory machine-readable storage medium of claim 3,
the potential actions are first potential actions based on a first state of the wireless network;
the implementation of the selected action is to move the wireless network to a second state; and
the instructions cause the programmable circuitry to:
generate second potential actions based on the second state of the wireless network;
randomly or pseudo-randomly identify ones of the second potential actions;
execute the second machine learning model to select one of the randomly or pseudo-randomly identified actions; and
implement the newly selected action.

16. The non-transitory machine-readable storage medium of claim 3, wherein:
the potential actions are first potential actions based on a first state of the wireless network;
the implementation of the selected action is to move the wireless network to a second state; and
the instructions cause the programmable circuitry to:
randomly or pseudo-randomly re-assign client devices to base station devices to move the wireless network to a third state; and
generate second potential actions based on the third state of the wireless network.

17. The non-transitory machine-readable storage medium of claim 3, wherein to generate the potential actions, the instructions cause the programmable circuitry to identify client devices that are approximately equidistant between two or more base station devices.

18. The non-transitory machine-readable storage medium of claim 3, wherein:
the client device is a first client device;
the potential actions are first potential actions corresponding to a first client device; and
the instructions cause the programmable circuitry to generate second potential actions to, if implemented, create an initial assignment between a second client device and a base station device in the wireless network.

19. A method to perform load balancing in a network, the method comprising:
generating potential actions to, if implemented, re-assign a client device in a wireless network from a first base station device in the wireless network to another base station device in the wireless network, wherein the re-assignment is to cause the first base station device to stop communications with the client device and is to cause the another base station device to begin communications with the client device;
executing a first machine learning model to predict which of the potential actions would satisfy a quality of service (QOS) threshold;
executing a second machine learning model to select one of the potential actions predicted to satisfy the QoS threshold; and
implementing the selected action within the wireless network.

20. The method of claim 19, wherein executing the first machine learning model includes:
generating, using a neural network, a scalar value for one or more of the potential actions;
mapping, using a sigmoid function, scalar values to decimal values between zero and one; and
determining whether a scalar value associated with a given graph is greater or equal to the QoS threshold.
